(19) United States
(12) Patent Application Publication
(10) Pub. No.: US 2026/0194079 A1
(43) Pub. Date: Jul. 9, 2026

(54) REMOTE TRAVEL FEEDBACK SYSTEMS AND RELATED METHODS

(71) Applicant: Fisher Controls International LLC, Marshalltown, IA (US)

(72) Inventors: Abraham Marvin Bischof, Ames, IA (US); Timothy Arthur McMahon, Marshalltown, IA (US)

(21) Appl. No.: 19/440,251

(22) Filed: Jan. 5, 2026

Related U.S. Application Data
(60) Provisional application No. 63/742,726, filed on Jan. 7, 2025.

(51) Int. Cl. F15B 13/043; F15B 9/09; F15B 13/16; F15B 15/14; F15B 15/20

(52) U.S. Cl. CPC F15B 13/043; F15B 9/09; F15B 13/16; F15B 15/1447; F15B 2015/206; F15B 2211/322; F15B 2211/7051

(57) ABSTRACT

Remote travel feedback systems and related methods are disclosed. A valve position feedback system disclosed herein includes a valve, an actuator operatively coupled to the valve, a pressurized fluid supply fluidly coupled to the actuator, the fluid supply spaced apart from the valve and the actuator, and a coupler to operatively couple the actuator to the fluid supply, the coupler to adjust a feedback signal in the fluid supply based on a position of the actuator, the fluid supply to provide an output to the actuator based on the feedback signal and an input signal.

### RELATED APPLICATION

This patent claims the benefit of U.S. Provisional Patent Application No. 63/742,726, which was filed on January 7, 2025. U.S. Provisional Patent Application No. 63/742,726 is hereby incorporated herein by reference in its entirety. Priority to U.S. Provisional Patent Application No. 63/742,726 is hereby claimed.

### FIELD OF THE DISCLOSURE

This disclosure relates generally to process control devices and, more particularly, to remote travel feedback systems and related methods.

### BACKGROUND

Industrial plants and manufacturers have developed and implemented valve systems for fluid flow control. These known valve systems monitor and control fluid valves to govern process fluids (e.g., natural gas, water, etc.) within a process control system. In particular, the controlled valves vary flow of the process fluids by moving or displacing flow control members, such as valve plugs.

### BRIEF DESCRIPTION OF THE DRAWINGS

FIG. 1 is a schematic representation of a first example travel feedback system including a first example coupler and a control valve in a first position.

FIG. 2 is a schematic representation of the first example travel feedback system of FIG. 1 including the first example coupler and the control valve in a second position.

FIG. 3 is a schematic representation of the first example travel feedback system of FIGS. 1 and 2 including the first example coupler and the control valve in a third position.

FIG. 4 is a schematic representation of a second example travel feedback system including a second example coupler and the control valve in the first position.

FIG. 5 is a schematic representation of the second example travel feedback system of FIG. 4 including the second example coupler and the control valve in the second position.

FIG. 6 is a schematic representation of the second example travel feedback system of FIGS. 4 and 5 including the second example coupler and the control valve in the third position.

FIG. 7 is a schematic representation of a third example travel feedback system including a third example coupler and the control valve in the first position.

FIG. 8 is a schematic representation of the third example travel feedback system of FIG. 7 including the third example coupler and the control valve in the second position.

FIG. 9 is a schematic representation of the third example travel feedback system of FIGS. 7 and 8 including the third example coupler and the control valve in the third position.

FIG. 10 is a schematic representation of another example travel feedback system including the first example coupler of FIGS. 1-3.

FIG. 11 is a schematic representation of another example travel feedback system including the first example coupler of FIGS. 1-3 and 10.

FIG. 12 is a schematic representation of another example travel feedback system including the second example coupler of FIGS. 4-6.

FIG. 13 is a schematic representation of another example travel feedback system including the second example coupler of FIGS. 4-6 and 12.

FIG. 14 is a schematic representation of another example travel feedback system including the third example coupler of FIGS. 7-9.

FIG. 15 is a schematic representation of another example travel feedback system including the second example coupler of FIGS. 7-9 and 14.

FIG. 16 is a block diagram of a travel feedback system including the first example coupler of FIGS. 1-3 and 10-11.

FIG. 17 is a block diagram of a travel feedback system including the second example coupler of FIGS. 4-6 and 12-13.

FIG. 18 is a block diagram of a travel feedback system including the third example coupler of FIG. 7-9 and 14-15.

In general, the same reference numbers will be used throughout the drawing(s) and accompanying written description to refer to the same or like parts. The figures are not necessarily to scale.

### DETAILED DESCRIPTION

In order to accurately control fluid flow via a process control valve, a valve positioner continuously monitors a position of the valve. In some instances, the valve positioner is mounted directly to the valve and/or an actuator associated therewith to monitor the position. However, such positioners are susceptible to vibrations that can result from movement of the actuator, fluid flow parameters, and/or other processes. The vibrations can affect the accuracy of the position detected by the valve positioner and/or result in a leakage of the fluid. Such leakage is especially undesirable with certain fluids, such as natural gas, given an impact on the environment and industry regulations. For instance, the United States Environmental Protection Agency (EPA) has enacted regulations (e.g., 40 C.F.R. 60 Subparts OOOOb and OOOOc) that do not allow process controllers powered by a pipeline pressure to bleed instrument supply gas to the atmosphere. Further, current systems that enable the valve positioner to be remotely mounted require active electrical power to be supplied from an external power supply to sense a movement and/or position of the valve and transmit a signal to the remote mounted valve positioner.

Remote travel feedback systems (e.g., mechanical valve position remote feedback systems) that operate without an active power supply are disclosed herein. Examples disclosed herein provide a mechanical sensing element, also referred to herein as a coupler, that enables valve positioners that would otherwise be directly mounted to the valve to be converted to a remotely mounted, no-bleed pneumatic positioner. That is, examples disclosed herein include a mechanical travel feedback coupler that couples a control valve to a remotely mounted valve positioner associated with the control valve. For example, the coupler can be coupled to a valve stem that translates or rotates as the valve moves. Movement of the control valve can cause at least a portion of the coupler to move.

As a result, the movement of the coupler can result in a feedback signal that produces movement in the remote valve positioner. For example, the movement of the mechanical travel feedback sensor can change a compression in a spring of the remote valve positioner. The compression of the spring can correspond to the feedback signal. Further, the change in the compression in the spring can adjust a pressure encountered by a pressure control system. The pressure affects an output of the pressure control system, which controls the valve position (e.g., causes the valve to move). For example, the spring load can be summed against a force that results from an input pressure (e.g., a pressure that corresponds to a desired position of the valve, an input signal) and acts in an opposite direction from the spring load against a diaphragm of the pressure control system. In some examples, an imbalance between the spring load (e.g., the feedback signal) and the force from the input pressure (e.g., the input signal) can result in a movement of a positioner drivetrain that adjusts a position of a fill valve and/or a vent valve therein to change an output pressure. The output pressure from the pressure control system can be relayed to an actuator of the valve to implement a corresponding valve position adjustment. The output pressure can cause the actuator to move the valve until a balance between the spring load and the force from the input pressure is obtained.

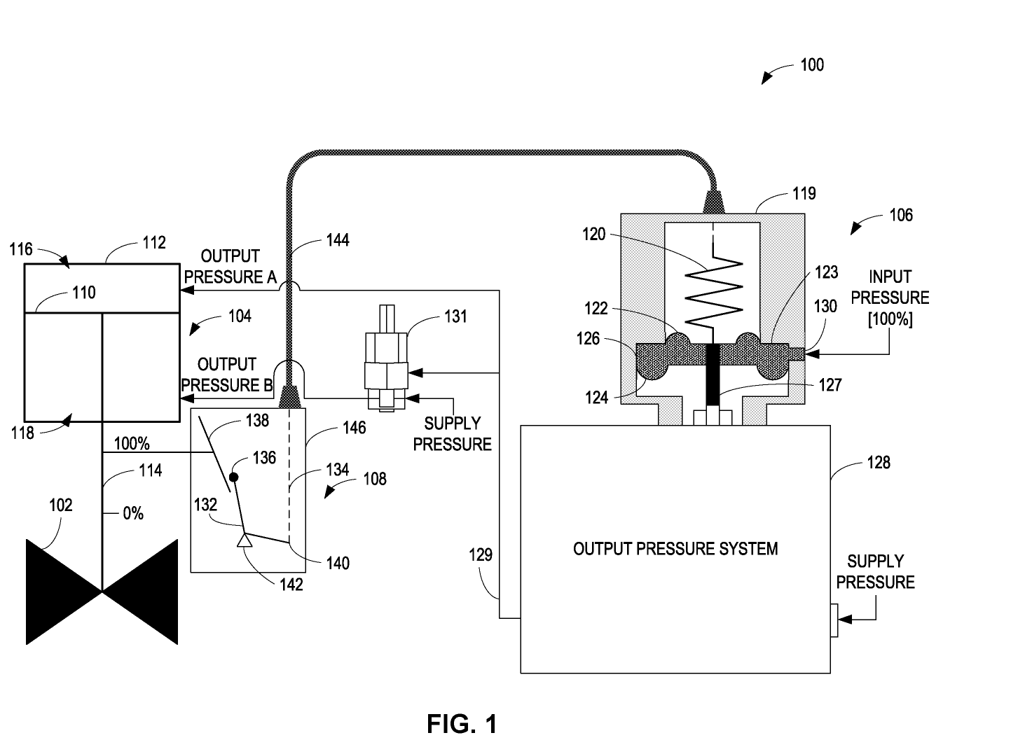

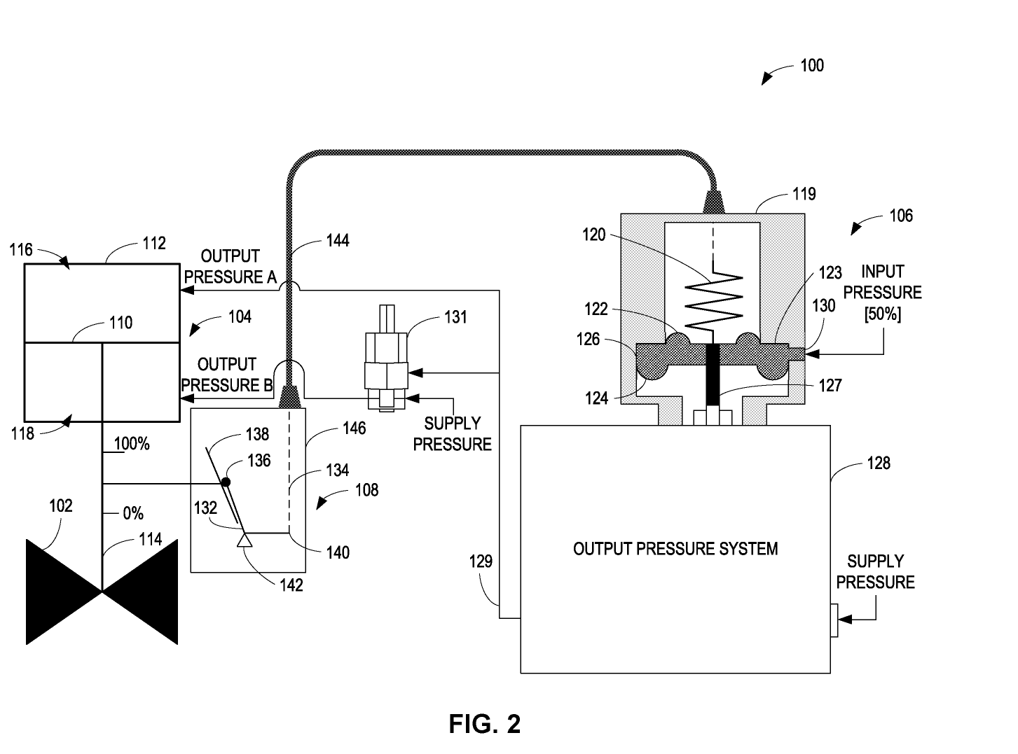

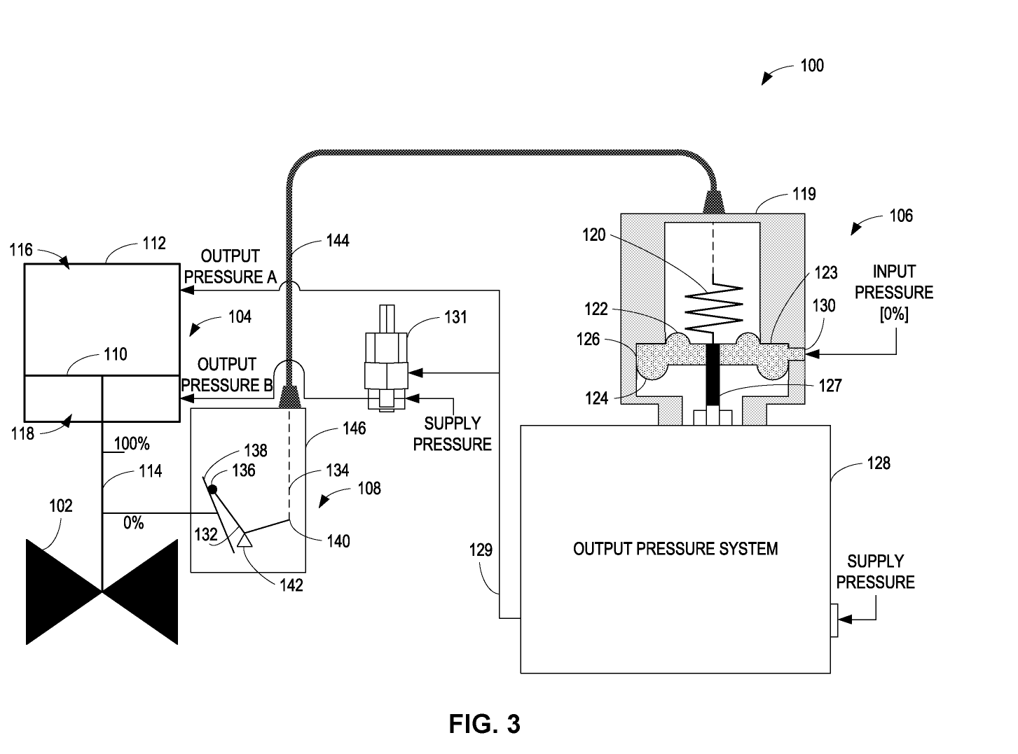

Referring now to the figures, FIGS. 1, 2, and 3 are schematic representations of a first example travel feedback system 100 including a control valve 102 in different positions. Specifically, FIG. 1 is a schematic representation of the first example travel feedback system 100 including the control valve 102 in a first position (e.g., a 100% span position, a fully open position). FIG. 2 is a schematic representation of the first example travel feedback system 100 including the control valve 102 in a second position (e.g., a 50% span position, a half-open position). FIG. 3 is a schematic representation of the first example travel feedback system 100 including the control valve 102 in a third position (e.g., a 0% span position, a fully closed position).

In the illustrated examples of FIGS. 1-3, an actuator 104 is operatively coupled to the control valve 102 to control a position thereof and, in turn, a fluid flow rate (e.g., in a pipe in which the control valve 102 is positioned). A pressurized fluid supply 106 (e.g., a pressurized fluid supply system, Fisher Positioner Module Type 4680) is fluidly coupled to the actuator 104. In the illustrated examples of FIGS. 1-3, the travel feedback system 100 includes a coupler 108 to operatively couple the actuator 104 and/or the valve 102 to the pressurized fluid supply 106. The coupler 108 provides travel and/or position feedback information associated with the actuator 104 and/or the valve 102 to the pressurized fluid supply 106. As such, the coupler 108 enables the pressurized fluid supply 106 to adjust an output that controls the position of the actuator 104 and/or the valve 102 when the travel and/or position feedback information indicates that the position of the actuator 104 and/or the valve 102 does not correspond to a desired position (e.g., a position associated with an input received by the pressurized fluid supply 106).

In the illustrated examples of FIGS. 1-3, the actuator 104 is a double acting piston actuator. As such, the actuator 104 includes a piston 110 positioned in a chamber 112 and coupled to a valve stem 114. The chamber 112 includes separate pressure sections 116, 118 (e.g., a first pressure section 116 and a second pressure section 118) defined on opposite sides of the piston 110 that are fluidly coupled to the pressurized fluid supply 106. As such, the pressurized fluid supply 106 controls a fluid pressure in the pressure sections 116, 118 to control a position of the piston 110. An end of the valve stem 114 opposite the piston 110 is coupled to the control valve 102. As such, the control valve 102 adjusts a fluid flow rate in response to movement of the piston 110 and the valve stem 114.

In the illustrated examples of FIGS. 1-3, the pressurized fluid supply 106 includes a housing 119, a spring 120, a first diaphragm 122, a second diaphragm 124, a fluid chamber 126 defined between the diaphragms 122, 124, an output shaft 127, and an output pressure system 128. For example, the output pressure system 128 can be implemented using the Fisher Type 4680 Base Module. The fluid chamber 126 includes an inlet 130. The inlet 130 receives an input pressure that corresponds to a desired position to be implemented by the valve 102. For example, the input pressure can be provided by a current to pressure (I/P) converter that translates an electrical signal (e.g., a 4-20 milliamp (mA) signal) to a fluid pressure (e.g., a 3-15 pounds per square inch gauge (psig) pneumatic output) indicative of the desired position for the valve 102.

The first diaphragm 122 is operatively coupled to a first end of the spring 120. As such, a first side of the first diaphragm 122 receives a load from the spring 120. The housing 119 defines an annular protrusion 123 positioned around the first diaphragm 122 opposite the second diaphragm 124. The annular protrusion 123 defines a fixed surface positioned opposite the second diaphragm 124, which causes the fluid pressure in the chamber 126 to push against the second diaphragm 124 (e.g., downwards in the orientation of FIGS. 1-3). The output shaft 127 is operatively coupled to the first diaphragm 122 and the second diaphragm 124. As such, the output shaft 127 receives a first load in a first direction (e.g., upwards in the orientation of FIGS. 1-3) from the spring 120. The output shaft 127 also receives a second load from the input pressure applied to the second diaphragm 124 in a second direction (e.g., downwards in the orientation of FIGS. 1-3).

As such, a load in (e.g., a compression of) the spring 120 is summed against the input pressure in the fluid chamber 126. An imbalance between the load applied by the spring 120 and the input pressure causes movement of the output shaft 127, which produces movement in the output pressure system 128. For example, the movement in the output pressure system 128 can adjust a position(s) of a fill valve and/or a vent valve that increases or decreases, respectively, a fluid pressure output 129 by the output pressure system 128.

In turn, the fluid pressure output 129 controls the position of the actuator 104 and the valve 102. In this example, the fluid pressure output 129 is delivered to the first pressure section 116 and a pneumatic reversing relay 131 fluidly coupled to the second pressure section 118. The fluid pressure output 129 corresponds to output pressure B that is supplied to the first section 116 of the chamber 112. The pneumatic reversing relay 131 outputs an inverse of the fluid pressure output 129, which corresponds to output pressure A. Specifically, when the fluid pressure output 129 increases, the pneumatic reversing relay 131 causes the output pressure A to decrease. Further, when the fluid pressure output 129 decreases, the pneumatic reversing relay 131 causes the output pressure A to increase. Accordingly, the first pressure section 116 and the second pressure section 118 encounter pressure changes in opposite directions (e.g., an increase in pressure and a decrease in pressure) to move the piston 110 in response to a change in output from the output pressure system 128. In turn, the movement of the piston 110 moves the valve stem 114 and the control valve 102.

In the illustrated examples of FIGS. 1-3, the coupler 108 includes a lever 132 (e.g., a mechanical linkage) operatively coupled to a cable 134. A first end 136 of the lever 132 is operatively coupled to the actuator 104 and/or the valve 102. The lever 132 pivots as the actuator 104 and/or the valve 102 moves. In this example, the first end 136 of the lever 132 is engaged with a projection 138 that extends from the valve stem 114. Specifically, the first end 136 is weighted to cause the first end 136 to rest against the projection 138 under the force of gravity. Alternatively, the first end 136 and the projection 138 can be engaged in another manner, such as via magnetic attraction, a slidable fastener, etc. In some examples, the first end 136 includes a gear that engages with gear teeth on the valve stem 114, the projection 138, and/or the valve 102. For example, the valve stem 114 can include a cam, and the lever 132 can include a cam follower engaged therewith.

In the illustrated examples of FIGS. 1-3, as the valve stem 114 translates, the projection 138 moves the first end 136 of the lever 132, which causes a second end 140 of the lever 132 to pivot about a fulcrum 142. The second end 140 is operatively coupled to a first end of the cable 134. A second end of the cable 134 is operatively coupled to the spring 120. Specifically, the cable 134 is a tension cable that adjusts the load in (e.g., the compression in, the extension of) the spring 120 when the lever 132 moves. The cable 134 can include a sheath 144 positioned around a load supporting material (e.g., steel, fibers, etc.) from a housing 146 containing the lever 132 to the housing 119 associated with pressurized fluid supply 106. The sheath 144 protects the cable 134 from external conditions as the cable 134 spans from the location associated with the valve 102 to the remotely positioned pressurized fluid supply 106.

In this example, the lever 132 causes the tension in the cable 134 to increase as the valve stem 114 moves towards a 100% span position. The increased tension in the cable 134 results in increased tension in the spring 120, which increases a force that the spring 120 applies to the first diaphragm 122 in a first direction (e.g., a direction away from the fluid chamber 126). When the valve stem 114 is at the 100% span position, the cable 134 applies a corresponding 100% tension force on the spring 120, which the spring 120 relays to the first diaphragm 122. The 100% span position of the valve stem 114 can be the target position associated with a 100% input pressure of the fluid received at the inlet 130. Conversely, the lever 132 causes the tension in the cable 134, and, in turn, the spring 120, to decrease as the valve stem 114 moves away from the 100% span position. The reduced tension in the cable 134 results in reduced tension/increased compression in the spring 120, which increases a force that the spring 120 applies to the first diaphragm 122 in a second direction opposite the first direction (e.g., a direction towards the fluid chamber 126). Thus, the tension that the coupler 108 applies to the cable 134 and, in turn, the spring 120, corresponds to a feedback signal that the coupler 108 delivers to the pressurized fluid supply 106. The feedback signal is indicative of an observed position of the valve 102 and/or the actuator 104.

During operation, when the valve stem 114 is at the 100% span position and the chamber 126 receives an input pressure (e.g., an input signal) that is less than the 100% input pressure, the coupler 108 applies a greater load (e.g., provides a feedback signal having an increased force) on the first diaphragm 122 in the first direction than the input pressure applies to the second diaphragm 124 in the second direction when the first diaphragm 122, the second diaphragm 124, and the output shaft 127 are in an equilibrium position (e.g., a design position) associated therewith. In turn, the output shaft 127 moves out of the equilibrium position (e.g., upwards in the orientation of FIGS. 1-3) to a position at which a first force from the compression/tension applied to the spring 120 by the coupler 108 is balanced with a second force from the pressure of the fluid in the chamber 126 applied to the second diaphragm 124. In turn, the movement of the output shaft 127 causes movement in the output pressure system 128, such as opening the vent valve and/or closing the fill valve. For example, the imbalance between the first force and the second force causes the shaft 127 to move in a first direction (e.g., towards the spring 120, upwards in the orientation of FIG. 1), which actuates the output pressure system 128 to open the vent valve and/or close the fill valve. In turn, the movement in the output pressure system 128 can increase the pressure in the first pressure section 116 and decrease the pressure in the second pressure section 118. As a result, the valve stem 114 moves away from the 100% span position (e.g., towards the 0% span position).

Further, as the valve stem 114 moves away from the 100% span position, the coupler 108 adjusts the feedback signal delivered to the pressurized fluid supply 106. Specifically, the lever 132 pivots to reduce a tension force applied to the cable 134 and, in turn, the spring 120. Thus, the load that the spring 120 imparts on the first diaphragm 122 is reduced, which enables the spring 120 to move towards a design position associated with the received input pressure in the chamber 126. As a result, the first force from the spring 120 on the first diaphragm 122 (e.g., the feedback signal) can become approximately equivalent (e.g., within 5% of equivalent) to the second force from the fluid in the chamber 126 on the second diaphragm 124 (e.g., the input signal) when the output shaft 127 is at the equilibrium position. When force that the spring 120 imparts on the first diaphragm 122 (e.g., the feedback signal) is approximately equivalent to the force that the pressure of the fluid in the chamber 126 applies on the second diaphragm 124 (e.g., the input signal), the first and second diaphragms 122, 124 and, in turn, the output shaft 127 are in equilibrium positions. When the output shaft 127 is in the equilibrium position, the output from the output pressure system 128 is a balanced output that causes the pressure in the first section 116 to be equivalent to the pressure in the second section 118, thereby holding the valve 102 in place. For example, the output shaft 127 is moved to/held in a position that closes both the fill valve and the vent valve of the output pressure system 128.

Conversely, when the valve stem 114 is at a position between the 100% span position and the 0% span position and the chamber 126 receives an input that corresponds to 100% input pressure, the cable 134 and, in turn, the spring 120 hold a reduced tension force. That is, the first force that the cable 134 causes the spring 120 to apply to the first diaphragm 122 (e.g., the feedback signal) is less than the second force that the fluid associated with the 100% input pressure applies to the second diaphragm 124 (e.g., the input signal). The summed forces between the spring 120 and the fluid in the chamber 126 results in movement of the first and second diaphragms 122, 124 and, in turn, the output shaft 127 out of the equilibrium positions associated therewith (e.g., downwards in the orientation of FIGS. 1-3).

Further, the movement of the output shaft 127 can cause the output pressure system 128 to open the fill valve and/or close the vent valve. In turn, the movement in the output pressure system 128 reduces the pressure in the first pressure section 116 and increases the pressure in the second pressure section 118. As a result, the valve stem 114 moves towards the 100% span position, which causes the coupler 108 to adjust the feedback signal. Specifically, the lever 132 pivots and increases a tension force applied to the cable 134 and, in turn, the spring 120. Thus, the force that the spring 120 applies to the first diaphragm 122 (e.g., a force associated with the feedback signal) is increased and approaches equilibrium with the force that the 100% input pressure of the fluid in the chamber 126 applies to the second diaphragm 124 (e.g., a force associated with the input signal) when the diaphragms 122, 124 and the output shaft 127 are in the equilibrium positions associated therewith. Accordingly, when the output shaft 127 is in the equilibrium position and the force that the spring 120 imparts on the first diaphragm 122 (e.g., the feedback signal) is approximately equivalent with the force that the pressure of the fluid in the chamber 126 applies on the second diaphragm 124 (e.g., the input signal), the output shaft 127 is held in the equilibrium position, and the output pressure system 128 supplies a balanced output to the actuator 104 that maintains the position of the valve 102.

Although, in this example, the coupler 108 applies the feedback signal in the form of a force on the first diaphragm 122, the coupler 108 can be operatively coupled to a pressurized fluid supply having a different configuration than that of the pressurized fluid supply 106 of FIGS. 1-3. In some examples, the coupler 108 can cause the tension in the cable 134 to provide the feedback signal in the form of another force that is summed against a force from the input signal. In some examples, the coupler 108 can cause the tension in the cable 134 to provide the feedback signal in the form of movement (e.g., travel) of a component, which is compared to the input signal. For example, the input signal can also move the component such that the movement inputs that result from the feedback signal and the input signal are summed. Alternatively, the input signal can move another component, and the movement of the two components can be compared to determine whether valve 102 is in the desired position.

Advantageously, the coupler 108 enables the pressurized fluid supply 106 to be spaced apart from (e.g., mounted in a remote location relative to) the valve 102 and the actuator 104. As such, the coupler 108 enables the travel position feedback to be provided to the pressurized fluid supply 106 without requiring the pressurized fluid supply 106 to be mounted on the valve 102 and/or the actuator 104, which would otherwise cause the pressurized fluid supply 106 to be susceptible to vibrations and/or fluid leakage. The coupler 108 also provides the travel feedback to the pressurized fluid supply 106 without utilization of an active electrical power supply. Specifically, the active electrical power supply would otherwise be utilized with a remotely mounted fluid supply (e.g., the pressurized fluid supply 106) to power a position sensor at the valve 102 and/or actuator, a transmitter associated with the position sensor, and circuitry at the fluid supply.

In some examples, the annular protrusion 123 of the housing 119 is positioned around the second diaphragm 124 opposite the first diaphragm 122. In such examples, the tension in the cable 134 decreases and the compression of the spring 120 increases as the projection 138 moves towards the 100% span position. That is, in such examples, the lever 132 can be inverted to cause the second end 140 to move upwards in the orientation of FIGS. 1-3 as the projection 138 moves towards the 100% span position.

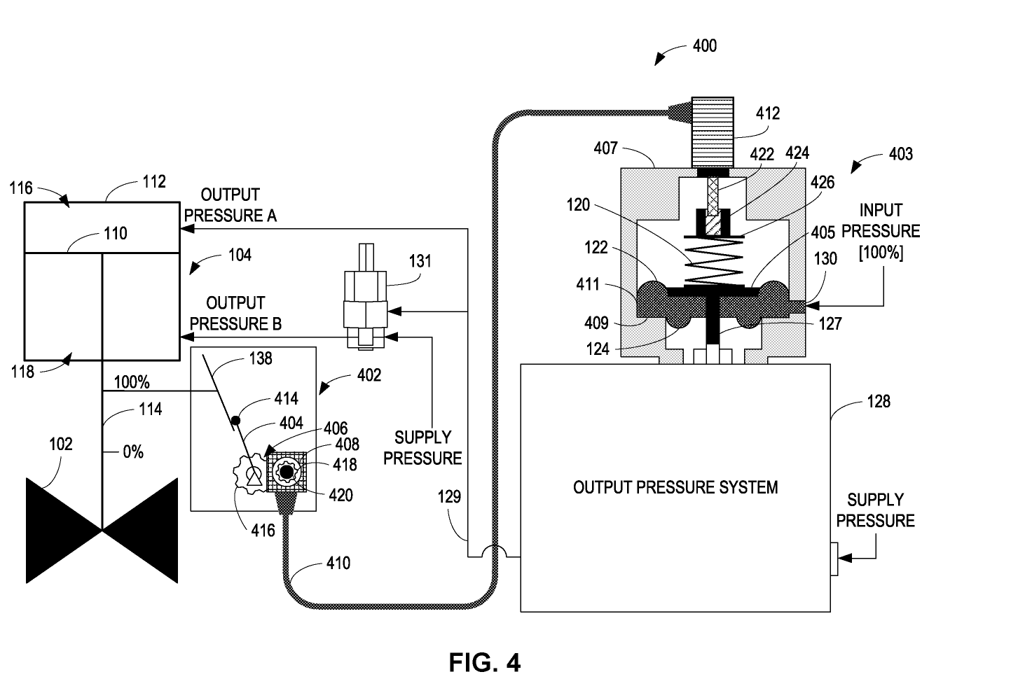

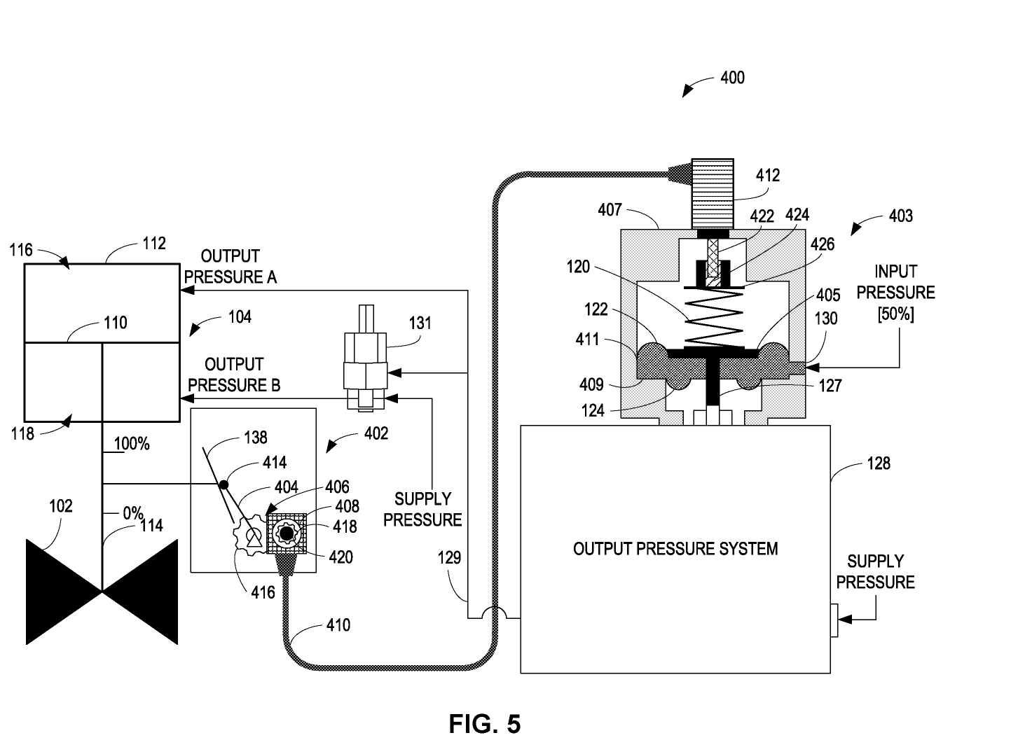

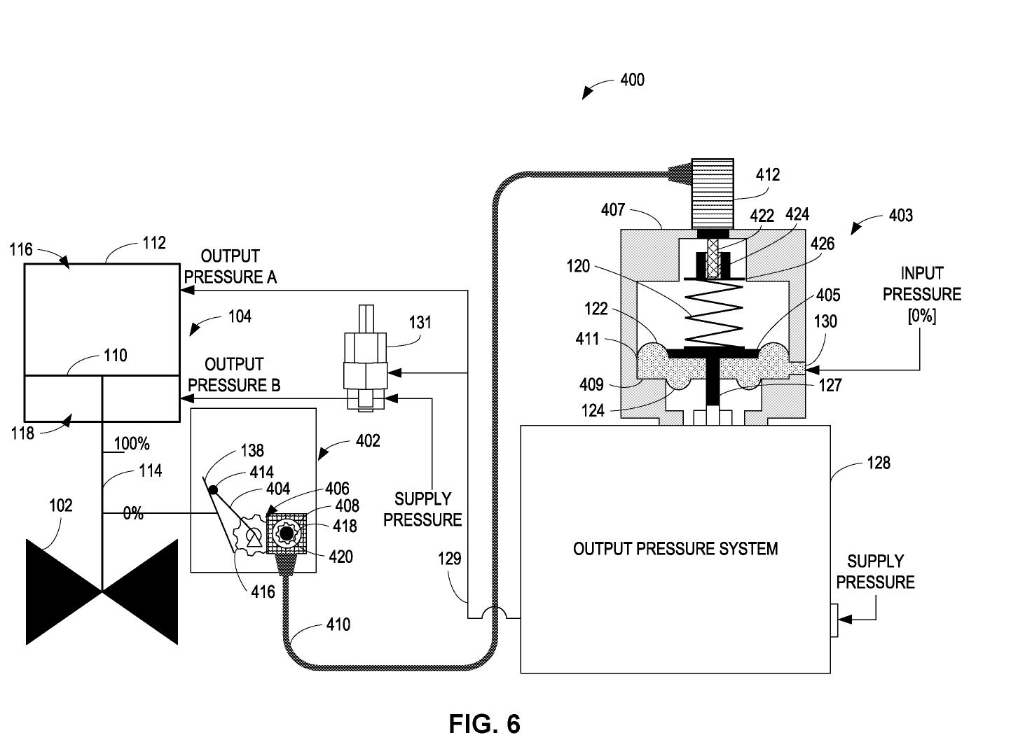

FIGS. 4, 5, and 6 are schematic representations of a second example travel feedback system 400 including the control valve 102 in different positions. Specifically, FIG. 4 is a schematic representation of the second example travel feedback system 400 including the control valve 102 in a first position (e.g., a 100% span position, a fully open position). FIG. 5 is a schematic representation of the second example travel feedback system 400 including the control valve 102 in a second position (e.g., a 50% span position, a half-open position). FIG. 6 is a schematic representation of the second example travel feedback system 400 including the control valve 102 in a third position (e.g., a 0% span position, a fully closed position).

In the illustrated examples of FIGS. 4-6, the second example travel feedback system 400 includes a second example coupler 402 and a second example pressurized fluid supply 403 (e.g., a pressurized fluid supply system, Fisher Positioner Module Type 4680). The travel feedback system 400 of FIGS. 4-6 also includes the valve 102, the actuator 104, the output pressure system 128, the fluid pressure output 129, and the pneumatic reversing relay 131 of FIGS. 1-3. Accordingly, reference is made to the description above for detailed discussion of the structure and operation of the valve 102, the actuator 104, the output pressure system 128, the fluid pressure output 129, and the pneumatic reversing relay 131.

In the illustrated examples of FIGS. 4-6, the pressurized fluid supply 403 includes a plate 405 fixed to an end of the output shaft 127. The plate 405 is operatively coupled to the spring 120 and the first diaphragm 122. Further, the pressurized fluid supply 403 includes another example housing 407. The housing 407 includes an annular protrusion 409 positioned around the second diaphragm 124 opposite the first diaphragm 122. The annular protrusion 409 defines a fixed surface positioned opposite a portion of the first diaphragm 122. As such, a chamber 411 of the pressurized fluid supply 403 of FIGS. 4-6 is configured inversely to that of the chamber 126 of FIGS. 1-3. As a result, positioning the annular protrusion 409 opposite the first diaphragm 122 causes the fluid pressure in the chamber 411 to apply a greater force on the first diaphragm 122 (e.g., upwards in the orientation of FIGS. 4-6) than the second diaphragm 124. Accordingly, a force from the fluid pressure in the chamber 411 acts on the first diaphragm 122 in a first direction (e.g., upwards in the orientation of FIGS. 4-6), and a force from the compression of the spring 120 acts on the first diaphragm 122 in a second direction opposite the first direction (e.g., downwards in the orientation of FIGS. 4-6).

In the illustrated examples of FIGS. 4-6, the second coupler 402 operatively couples the valve 102 and/or the actuator 104 to the spring 120 of the pressurized fluid supply 403. In this example, the coupler 402 includes a lever 404 (e.g., a mechanical linkage), a gear set 406, a driver stepper motor 408, an electrical coupling 410 (e.g., an electrical wire or cable), and a driven stepper motor 412. The lever 404 includes a first end 414 engaged with the projection 138 of the valve stem 114. In some examples, the first end 414 engages directly with the valve stem 114 or the valve 102. Similar to the lever 132 of FIGS. 1-3, the first end 414 is weighted to cause the first end 414 to rest against the projection 138 under the force of gravity. Alternatively, the first end 414 and the projection 138 can be engaged in another manner, such as via magnetic attraction, a slidable fastener, etc. In some examples, the first end 414 includes a gear that engages with gear teeth on the valve stem 114, the projection 138, and/or the valve 102.

In the illustrated examples of FIGS. 4-6, the gear set 406 operatively couples the lever 404 to the driver stepper motor 408. For example, the gear set 406 can include a first gear 416 fixed to the lever 404 and a second gear 418 fixed to the driver stepper motor 408 (e.g., a shaft 420 of the driver stepper motor 408). In some examples, the first gear 416 is engaged with the second gear 418 to convert a pivot movement encountered by the lever 404, as a result of translation of the projection 138, to a rotation of the second gear 418 and, in turn, the shaft 420 of the driver stepper motor 408. In some examples, the gear set 406 includes one or more intermediate gears to operatively couple the first gear 416 to the second gear 418. In such examples, the intermediate gears can provide a gear ratio that increases a rotation that the second gear 418 encounters from movement by the first gear 416.

The shaft 420 of the driver stepper motor 408 is magnetized such that rotation of the shaft 420 induces an electrical current in coils (e.g., windings) of the driver stepper motor 408 via back electromotive force (EMF). Further, the coils of the driver stepper motor 408 are electrically coupled to a first end of the electrical coupling 410. A second end of the electrical coupling 410 is coupled to the driven stepper motor 412. As such, the electrical coupling 410 carries the electrical current from the driver stepper motor 408 to the driven stepper motor 412. In turn, coils of the driven stepper motor 412 carry the electrical current, which causes a magnetized shaft 422 of the driven stepper motor 412 to rotate. Thus, the rotation of the shaft 420 of the driver stepper motor 408 causes rotation of the shaft 422 of the driven stepper motor 412.

Further, a voltage across the coils of the driver stepper motor 408 can be positive or negative based on a direction of rotation of the shaft 420 of the driver stepper motor 408. That is, rotation of the shaft 420 in a first direction (e.g., clockwise) can produce a positive voltage, and rotation of the shaft 420 in a second direction (e.g., counterclockwise) can produce a negative voltage. As a direction of rotation of the shaft 422 of the driven stepper motor 412 is based on the positive or negative voltage across the coils of the driven stepper motor 412, the direction of rotation of the shaft 422 of the driven stepper motor 412 is linked to the direction of rotation of the shaft 420 of the driver stepper motor 408. Accordingly, movement of the projection 138 in a first direction (e.g., towards the 100% span position) causes rotation of the shaft 422 of the driven stepper motor 412 in a first direction (e.g., clockwise), and movement of the projection 138 in a second direction (e.g., towards the 0% span position) causes rotation of the shaft 422 of the driven stepper motor 412 in a second direction opposite the first direction (e.g., counterclockwise). Additionally, a gear ratio associated with the gear set 406 can be configured to enable the movement of the lever 404 to produce a rotation of the shaft 420 of the driver stepper motor 408 that results in a desired electrical current and/or voltage, which causes a desired degree of rotation by the shaft 422 of the driven stepper motor 412.

In the illustrated examples of FIGS. 4-6, the shaft 422 of the driven stepper motor 412 is operatively coupled to an end of the spring 120 opposite the first diaphragm 122. For example, the shaft 422 can be threadably coupled to a bore 424 of a plate 426 fixed to an end of the spring 120. When the projection 138 encounters movement towards the 100% span position, the shaft 422 of the driven stepper motor 412 rotates in the first direction, which moves the plate 426 attached to the end of the spring 120 towards the first diaphragm 122, thereby increasing a compression in the spring 120 and, thus, the force that the spring 120 imparts on the first diaphragm 122 (e.g., a force associated with a feedback signal from the coupler 402). Further, when the projection 138 encounters movement towards the 0% span position, the shaft 422 of the driven stepper motor 412 rotates in the second direction, which moves the end of the spring 120 away from the first diaphragm 122 thereby reducing the compression in the spring 120 and, thus, the force that the spring 120 imparts on the first diaphragm 122 (e.g., the force associated with a feedback signal from the coupler 402). As such, the coupler 402 causes the spring 120 to impart a force on the first diaphragm 122 (e.g., the feedback signal) that corresponds with a position of the projection 138. In this example, the feedback force that the coupler 402 applies to the spring 120 increases a compression of the spring 120 as the projection 138 moves towards the 100% span position, which is the inverse of the coupler 108 of FIGS. 1-3, which reduces a compression in the spring 120 as the projection 138 moves towards the 100% span position.

During operation, when the valve stem 114 is at the 100% span position and the chamber 411 receives an input that is less than the 100% input pressure, the coupler 402 causes the spring 120 to impart a first force (e.g., a feedback signal) on the first diaphragm 122 that is greater than a second force that the first diaphragm 122 encounters from the fluid pressure in the chamber 411 (e.g., an input signal) when the first diaphragm 122 is in the equilibrium position associated therewith. Unequal forces on the first diaphragm 122 when in the equilibrium position cause the first diaphragm 122, and, in turn, the plate 405 and the output shaft 127, to move to a position at which the forces become balanced (e.g., by reducing a compression in the spring 120). Accordingly, the difference between the first force (e.g., the feedback signal) and the second force (e.g., the input signal) causes the output pressure system 128 to open a fill valve and close a vent valve, which moves the valve 102 and the projection 138 towards the 0% span position.

As the valve 102 moves, the lever 404 pivots, which drives the gear set 406 to rotate the shaft 420 of the driver stepper motor 408 in a first direction. Further, the rotation of the shaft 420 of the driver stepper motor 408 produces an electrical current that the electrical coupling 410 carries to the driven stepper motor 412. As a result, the shaft 422 of the driven stepper motor 412 rotates and causes the plate 426 to move towards the driven stepper motor 412. In turn, the coupler 402 reduces the compression in the spring 120, which can cause the first force (e.g., the feedback signal) and the second force (e.g., the input signal) to become approximately equivalent when the first diaphragm 122 is at an equilibrium position. Accordingly, the output pressure system 128 supplies a balanced output to the actuator 104.

Conversely, when the valve stem 114 is at a position between the 0% and 100% span positions, the chamber 411 receives an input that corresponds with 100% input pressure, and the first diaphragm 122 is at the equilibrium position, the first force (e.g., the feedback signal) that the coupler 402 causes the spring 120 to impart on the first diaphragm 122 is less than the second force (e.g., the input signal) that the first diaphragm 122 encounters from the fluid pressure in the chamber 411. As such, the first diaphragm 122, and, in turn, the plate 405 and the output shaft 127, move out of the equilibrium position associated therewith (e.g., downwards in the orientation of FIGS. 4-6, towards the second diaphragm 124). As a result, the output pressure system 128 can close the fill valve and open the vent valve associated therewith to move the valve 102 and the projection 138 towards the 100% span position.

In the illustrated examples of FIGS. 4-6, as the valve 102 moves, the lever 404 pivots, which drives the gear set 406 to rotate the shaft 420 of the driver stepper motor 408 in a second direction opposite the first direction. Further, the rotation of the shaft 420 of the driver stepper motor 408 produces an electrical current that the electrical coupling 410 carries to the driven stepper motor 412. As a result, the shaft 422 of the driven stepper motor 412 rotates and causes the plate 426 to move away from the driven stepper motor 412. In turn, the coupler 402 increases the compression in the spring 120, which can cause the first force (e.g., the feedback signal) and the second force (e.g., the input signal) to become approximately equivalent when the first diaphragm 122 is at an equilibrium position. Accordingly, the first diaphragm 122 moves to an equilibrium position associated therewith, and the output pressure system 128 supplies a balanced output to the actuator 104. Thus, the output pressure system 128 can supply the first section 116 and the second section 118 of the chamber 112 with equal pressures to maintain a position of the valve 102.

Although, in this example, the coupler 402 applies the feedback signal in the form of a force on the first diaphragm 122, the coupler 402 can be operatively coupled to a pressurized fluid supply having a different configuration than that of the pressurized fluid supply 403 of FIGS. 4-6. In some examples, the coupler 402 can cause the driven stepper motor 412 to provide the feedback signal in the form of another force that is summed against a force from the input signal. In some examples, the coupler 402 can cause the driven stepper motor 412 to provide the feedback signal in the form of movement (e.g., travel) of a component, which is compared to the input signal. For example, the input signal can also move the component such that the movement inputs that result from the feedback signal and the input signal are summed. Alternatively, the input signal can move another component, and the movement of the two components can be compared to determine whether valve 102 is in the desired position.

Advantageously, the coupler 402 enables the pressurized fluid supply 403 to be spaced apart from (e.g., mounted in a remote location relative to) the valve 102 and the actuator 104. As such, the coupler 402 enables the travel position feedback to be provided to the pressurized fluid supply 403 without requiring the pressurized fluid supply 403 to be mounted on the valve 102 and/or the actuator 104, which would otherwise cause the pressurized fluid supply 403 to be susceptible to vibrations and/or fluid leakage. The coupler 402 also provides the travel feedback to the pressurized fluid supply 403 without utilization of an active electrical power supply. Specifically, the active electrical power supply would otherwise be utilized with a remotely mounted fluid supply (e.g., the pressurized fluid supply 403) to power a position sensor at the valve 102 and/or actuator, a transmitter associated with the position sensor, and circuitry at the fluid supply.

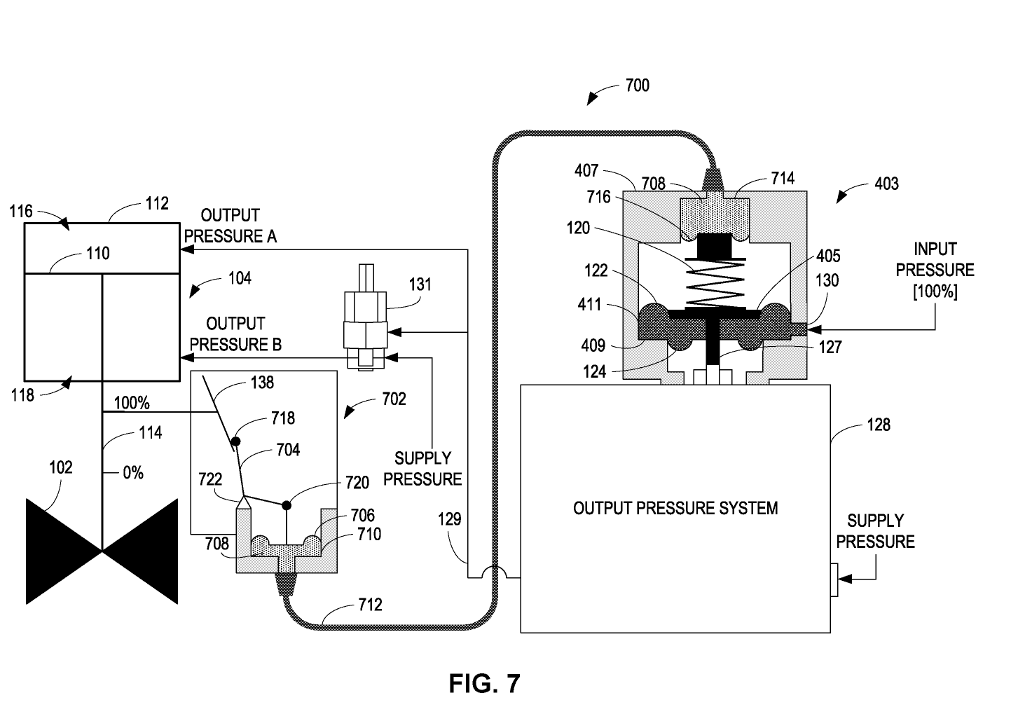

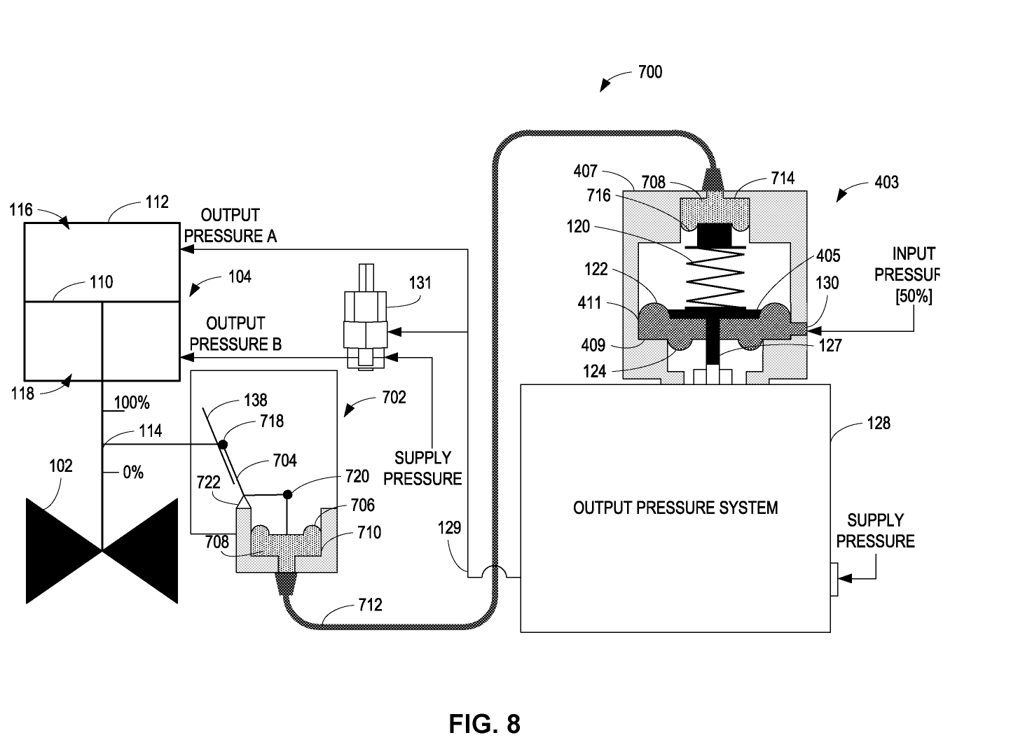

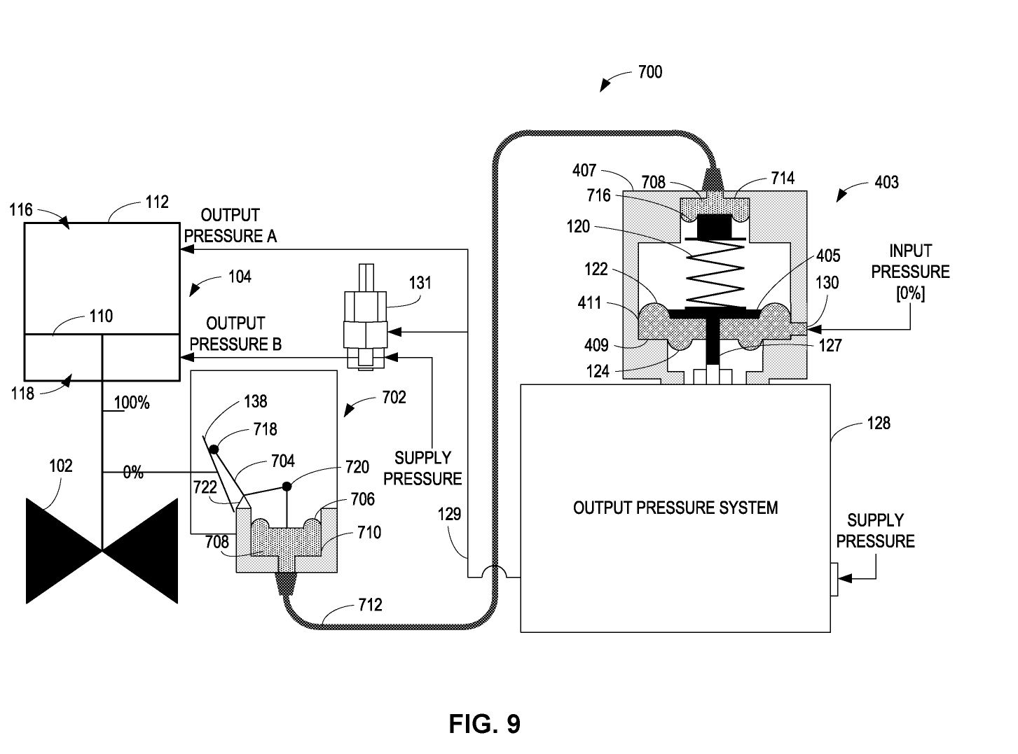

FIGS. 7, 8, and 9 are schematic representations of a third example travel feedback system 700 including the control valve 102 in different positions. Specifically, FIG. 7 is a schematic representation of the third example travel feedback system 700 including the control valve 102 in a first position (e.g., a 100% span position, a fully open position). FIG. 8 is a schematic representation of the third example travel feedback system 700 including the control valve 102 in a second position (e.g., a 50% span position, a half-open position). FIG. 9 is a schematic representation of the third example travel feedback system 700 including the control valve 102 in a third position (e.g., a 0% span position, a fully closed position).

In the examples of FIGS. 7-9, the third example travel feedback system 700 includes a third example coupler 702. The third example travel feedback system 700 otherwise corresponds with the second example travel feedback system 400 of FIGS. 4-6. Reference numbers for shared components from the second example travel feedback system 4-6 have been carried over into the third example travel feedback system 700. As such, reference is made to the description above for detailed discussion of the structure and operations of the components of the third travel feedback system 700 other than the coupler 702.

In the illustrated examples of FIGS. 7-9, the coupler 702 includes a lever 704 (e.g., a mechanical linkage), a first diaphragm 706, a fluid 708 (e.g., an incompressible fluid), a first chamber 710, a tube 712, a second chamber 714, and a second diaphragm 716. The lever 704 includes a first end 718 engaged with the projection 138 of the valve stem 114. In some examples, the first end 718 engages directly with the valve stem 114 or the valve 102. In some examples, the first end 718 is weighted to cause the first end 718 to rest against the projection 138 under the force of gravity. Alternatively, the first end 718 and the projection 138 can be engaged in another manner, such as via magnetic attraction, a slidable fastener, etc. In some examples, the first end 718 includes a gear that engages with gear teeth on the valve stem 114, the projection 138, and/or the valve 102. In the illustrated examples of FIGS. 7-9, the lever 704 also includes a second end 720 and a fulcrum 722. The first end 718 and the second end 720 pivot about the fulcrum 722 as the projection 138 translates. The second end 720 is operatively coupled to the first diaphragm 706.

The fluid 708 is flowable between the first chamber 710, the tube 712, and the second chamber 714. Accordingly, the first chamber 710, the tube 712, and the second chamber 714 are fluidly coupled. Further, the second diaphragm 716 of the coupler 702 is operatively coupled to an end of the spring 120 opposite the first diaphragm 122 of the pressurized fluid supply 403.

During operation, as the valve 102 moves, the lever 704 pivots. The second end 720 of the lever 704 moves the first diaphragm 706 to expand or contract the first chamber 710. As such, the movement of the lever 704 causes the first diaphragm 706 to expand or contract in response to movement of the lever 704 to increase or decrease a size of the first chamber 710. Specifically, as the projection 138 moves towards the first position of FIG. 7, the lever 704 causes the first diaphragm 706 to contract (e.g., reduces tension applied to the first diaphragm 706), which reduces a size (e.g., a volume) of the first chamber 710. The reduced size of the first chamber 710 moves more fluid into the second chamber 714 via the tube 712. For example, the contraction of the first diaphragm 706 causes a portion of the fluid 708 to move from the first chamber 710 into the tube 712, which causes another portion of the fluid 708 in the tube 712 (e.g., at an opposite end of the tube 712) to move into the second chamber 714 thereby increasing a volume of the fluid 708 in the second chamber 714. The increased volume of the fluid 708 in the second chamber 714 causes the second diaphragm 716 to expand. As a result, the second diaphragm 716 moves towards the spring 120, thereby compressing the spring 120. In turn, the spring 120 applies an increased force on the first diaphragm 122 of the pressurized fluid supply 403. Accordingly, as the projection 138 moves towards the 100% span position, the coupler 702 increases a load that the spring 120 applies to the first diaphragm 122. The volume of the fluid 708 in the second chamber 714 and, in turn, the compression of the spring 120 and/or the load that the spring 120 applies to the first diaphragm 122 correspond to the feedback signal that the coupler 702 provides to the pressurized fluid supply 403.

When the projection 138 moves towards the 0% span position of FIG. 9, the lever 704 causes the first diaphragm 706 to expand (e.g., increases tension applied to the first diaphragm 706), which increases the size of the first chamber 710. The increased size of the first chamber 710 causes more of the fluid 708 to move into the first chamber 710 and, in turn, move out of the second chamber 714. As such, the reduced volume of the fluid 708 in the second chamber 714 moves the second diaphragm 716 in a direction away from the spring 120, thereby reducing a load on the spring 120 and causing the spring 120 to expand. The reduced compression in the spring 120 reduces a load that the spring 120 applies on the first diaphragm 122 of the pressurized fluid supply 403. Accordingly, as the projection 138 moves towards the 0% span position, the coupler 702 reduces a load (e.g., the feedback signal) that the spring 120 applies on the first diaphragm 122.

During operation, when the valve stem 114 is at the 100% span position and the chamber 411 receives an input (e.g., an input signal) that is less than the 100% input pressure, the coupler 702 causes the spring 120 to impart a first force (e.g., a force associated with a feedback signal) on the first diaphragm 122 that is greater than a second force (e.g., a force associated with the input signal) that the first diaphragm 122 encounters from the fluid pressure in the chamber 411 when the first diaphragm 122 is in the equilibrium position associated therewith. Accordingly, the unequal forces on the first diaphragm 122 when in the equilibrium position causes the first diaphragm 122 to move to a position at which the forces become balanced (e.g., by reducing a compression in the spring 120). Further, the movement of the first diaphragm 122 results in movement of the output shaft 127. Accordingly, the difference between the first force and the second force causes the output pressure system 128 to open a fill valve and close a vent valve, which moves the valve 102 and the projection 138 towards the 0% span position. As the valve 102 moves, the lever 704 pivots to apply tension to the first diaphragm 706. As a result, an amount of the fluid 708 in the first chamber 710 of the coupler 702 increases and an amount of the fluid 708 in the second chamber 714 decreases. Further, the reduced amount of the fluid 708 in the second chamber 714 causes the second diaphragm 716 to move away from the spring 120, which reduces a compression of the spring 120. As a result, the first diaphragm 122 of the pressurized fluid supply 403 can move towards the equilibrium position associated therewith, and a first force that the spring 120 applies on the first diaphragm 122 in the equilibrium position can become approximately equivalent to a second force on the first diaphragm applied by the pressure of the fluid in the chamber 411.

Conversely, when the valve stem 114 is at a position between the 0% and 100% span positions, the chamber 411 receives an input that corresponds with 100% input pressure, and the first diaphragm 122 is at the equilibrium position, the first force that the coupler 702 causes the spring 120 to impart on the first diaphragm 122 is less than the second force that the first diaphragm 122 encounters from the fluid pressure in the chamber 411. As such, the first diaphragm 122 moves (e.g., downwards in the orientation of FIGS. 7-9, towards the second diaphragm 124), which causes the output shaft 127 to move out of the equilibrium position associated therewith. As a result, the output pressure system 128 can close the fill valve and open the vent valve associated therewith to move the valve 102 and the projection 138 towards the 100% span position.

In the illustrated examples of FIGS. 7-9, as the valve 102 moves, the lever 704 pivots and causes the first diaphragm 706 to reduce the size of the first chamber 710. In turn, the amount of the fluid 708 in the first chamber 710 of the coupler 702 decreases and the amount of the fluid 708 in the second chamber 714 increases. Further, the increased amount of the fluid 708 in the second chamber 714 causes the second diaphragm 716 to move towards the spring 120 and increase a compression of the spring 120. As a result, the increased compression of the spring 120 can cause the first diaphragm 122 to move towards the equilibrium position associated therewith. Further, a first force (e.g., the force associated with the feedback signal) that the spring 120 applies on the first diaphragm 122 in the equilibrium position can become approximately to a second force (e.g., the force associated with the input signal) on the first diaphragm 122 from the pressure of the fluid in the chamber 411.

Although, in this example, the coupler 702 applies the feedback signal in the form of fluid movement that applies a force on the first diaphragm 122, it should be understood that the coupler 702 can be operatively coupled to a pressurized fluid supply having a different configuration than that of the pressurized fluid supply 403 of FIGS. 7-9. In some examples, the coupler 702 can cause movement of the fluid 708 to provide the feedback signal in the form of another force that is summed against a force from the input signal. In some examples, the coupler 402 can cause the fluid 708 to provide the feedback signal in the form of movement (e.g., travel) of a component, which is compared to the input signal. For example, the input signal can also move the component such that the movement inputs that result from the feedback signal and the input signal are summed. Alternatively, the input signal can move another component, and the movement of the two components can be compared to determine whether valve 102 is in the desired position.

Advantageously, the coupler 702 enables the pressurized fluid supply 403 to be spaced apart from (e.g., mounted in a remote location relative to) the valve 102 and the actuator 104. As such, the coupler 702 enables the travel position feedback to be provided to the pressurized fluid supply 403 without requiring the pressurized fluid supply 403 to be mounted on the valve 102 and/or the actuator 104, which would otherwise cause the pressurized fluid supply 403 to be susceptible to vibrations and/or fluid leakage. The coupler 702 also provides the travel feedback to the pressurized fluid supply 403 without utilization of an active electrical power supply. Specifically, the active electrical power supply would otherwise be utilized with a remotely mounted fluid supply (e.g., the pressurized fluid supply 403) to power a position sensor at the valve 102 and/or actuator, a transmitter associated with the position sensor, and circuitry at the fluid supply.

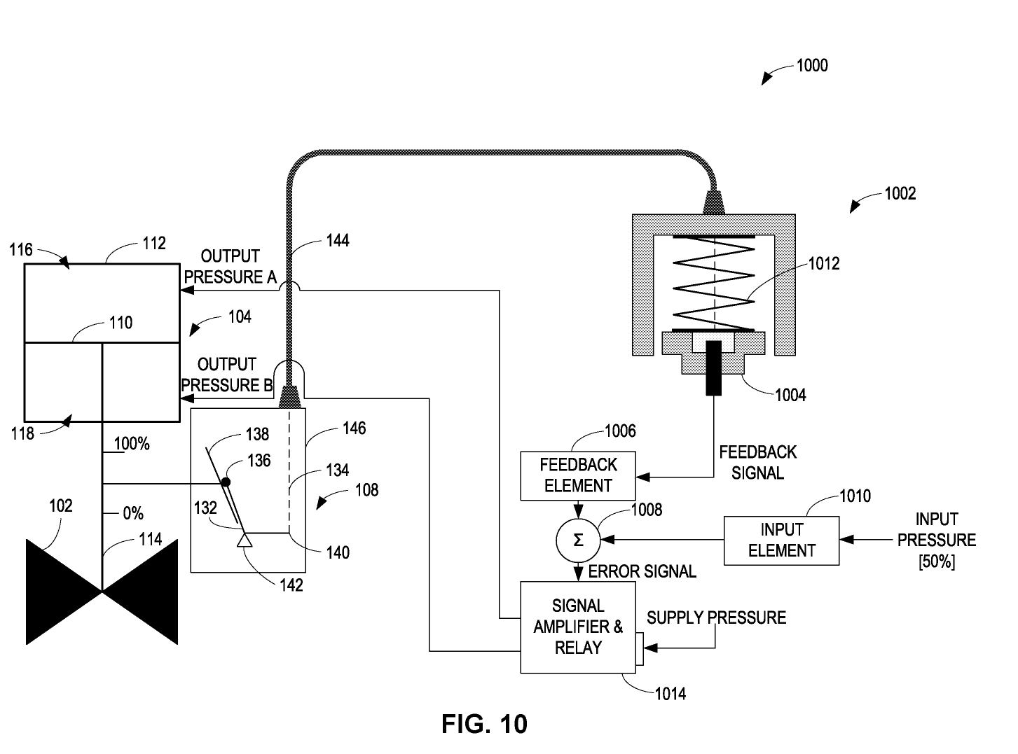

FIG. 10 is a schematic representation of another example travel feedback system 1000 including another example implementation of the coupler 108 of FIGS. 1-3. Specifically, FIG. 10 includes a schematic representation of another example pressurized fluid supply 1002 operatively coupled to the coupler 108 and the actuator 104. In this example, the coupler 108 provides a feedback signal to the pressurized fluid supply 1002 in the form of a movement/position of a platform 1004 fixedly coupled to an end of the cable 134 and/or a force that the cable 134 applies to the platform 1004.

The pressurized fluid supply 1002 relays the movement/position of the platform 1004 and/or the force applied to the platform 1004 to a feedback element 1006. In some examples, the platform 1004 implements the feedback element 1006. Additionally or alternatively, the feedback element 1006 can be implemented by the diaphragm 122 of FIGS. 1-9, the chamber 126 of FIGS. 1-3, the plate 405 of FIGS. 4-9, and/or the chamber 411 of FIGS. 4-9. The feedback element 1006, in turn, relays the encountered movement, position, and/or force to a summing element 1008 (e.g., a summing node). In some examples, the cable 134 is directly coupled to the feedback element 1006 and/or the platform 1004 implements the feedback element 1006.

The summing element 1008 is also operatively coupled to an input element 1010 that relays an input signal thereto. Similar to the feedback signal, the input element 1010 can relay the input signal to the summing element 1008 in the form of a movement/position and/or a force. As a result, the summing element 1008 compares a first movement, position, and/or force associated with the feedback signal to a second movement, position, and/or force associated with the input signal. The summing element 1008 outputs an error signal indicative of a difference between the first movement, position, and/or force and the second movement, position, and/or force.

In some examples, the pressurized fluid supply 1002 includes a spring 1012 operatively coupled to the platform 1004. The spring 1012 can have a spring rate that operates in conjunction with the tension in the cable 134 to enable the movement, position, and/or force that the platform 1004 relays to the feedback element 1006 to be indicative of an observed position of the valve 102. Specifically, the 50% span position of the valve 102 can cause the feedback element 1006 to relay a movement, position, and/or force to the summing element 1008 that is approximately equivalent to a movement, position, and/or force that the input element 1010 relays to the summing element 1008 when the 50% span position is desired.

Further, the pressurized fluid supply 1002 includes a signal amplifier and relay 1014 that adjusts one or more output pressures delivered to the actuator 104 based on the error signal. For example, the signal amplifier and relay 1014 can be implemented by the output pressure system 128 and the pneumatic reversing relay 131 of FIGS. 1-9.

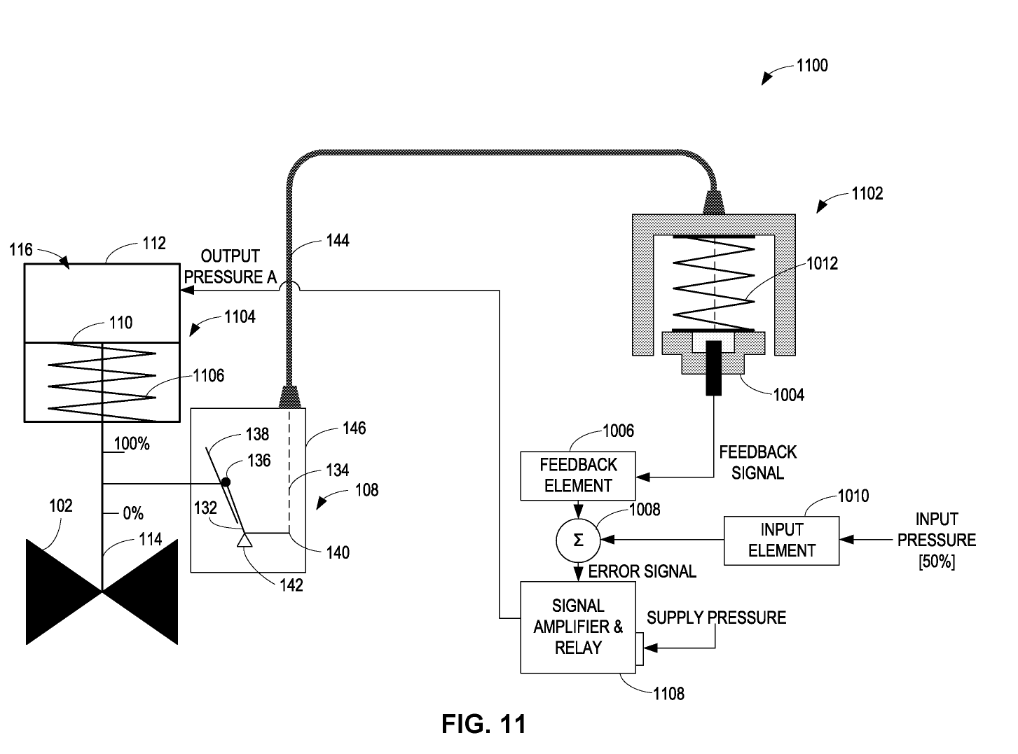

FIG. 11 is another schematic representation of another example travel feedback system 1100 including another example implementation of the coupler 108 of FIGS. 1-3 and 10. Specifically, FIG. 11 includes a schematic representation of another example pressurized fluid supply 1102 and another example actuator 1104. The actuator 1104 is a single acting piston actuator (e.g., Fisher Type 657) that includes a spring 1106 operatively coupled to the piston 110 opposite the first pressure section 116. As such, the spring 1106 provides a force against the piston 110 that functions similar to that of the pressure in the second section 118 of the chamber 112 of FIGS. 1-3 and 10.

The pressurized fluid supply 1102 includes the platform 1004, the feedback element 1006, the summing element 1008, the input element 1010, and the spring 1012. The pressurized fluid supply 1102 includes another example signal amplifier and relay 1108 configured to provide an output pressure to the first section 116 of the chamber 112 based on the error signal from the summing element 1008. For example, the signal amplifier and relay 1108 can correspond to the output pressure system 128 of FIGS. 1-9 that is fluidly coupled to the first section 116 of the chamber 112. Accordingly, the signal amplifier and relay 1108 does not include the pneumatic reversing relay 131 and a fluid connection to the second section 118 of the chamber 112.

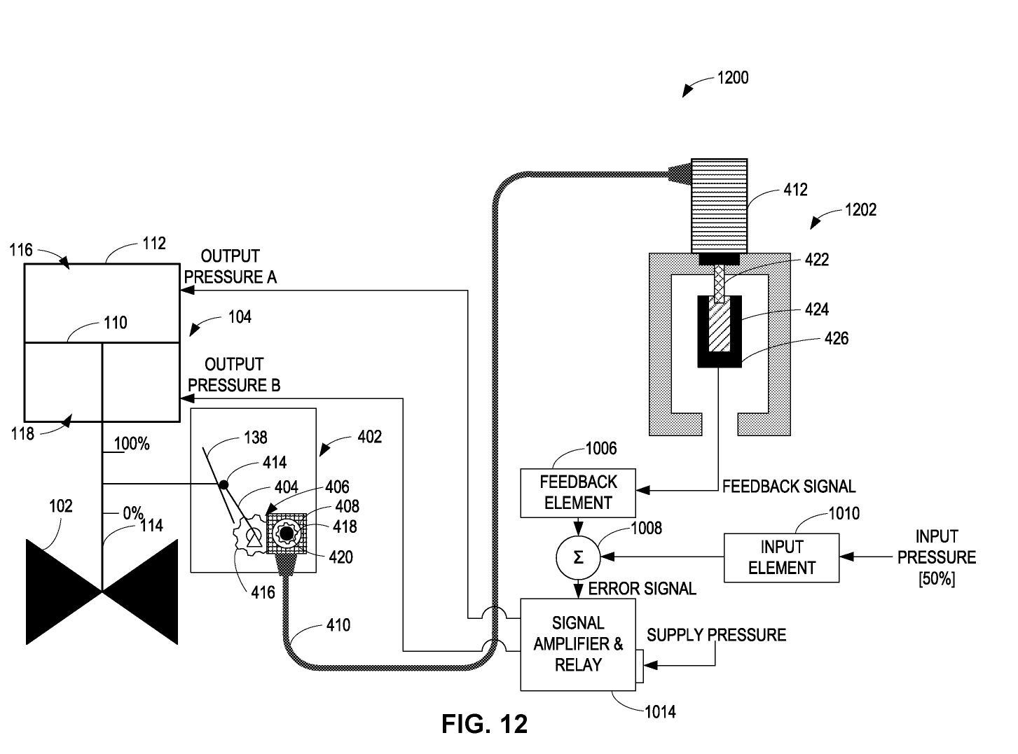

FIG. 12 is a schematic representation of another example travel feedback system 1200 including another example implementation of the coupler 402 of FIGS. 4-6. Specifically, FIG. 12 is a schematic representation of another example pressurized fluid supply 1202 operatively coupled to the coupler 402 and the actuator 104. The pressurized fluid supply 1202 includes the bore 424, the plate 426, the feedback element 1006, the summing element 1008, the input element 1010, and the signal amplifier and relay 1014.

The driven stepper motor 412 is operatively coupled to the feedback element 1006. In some examples, the feedback element 1006 relays a feedback signal, which can be in the form of movement/position of the plate 426 and/or a force that the plate 426 applies against another component (e.g., the spring 120 of FIGS. 4-9), to the summing element 1008. In this example, the driven stepper motor 412 is operatively coupled to the feedback element 1006 via the plate 426. In some examples, the shaft 422 of the driven stepper motor 412 is directly coupled to the feedback element and/or the plate 426 implements the feedback element 1006.

The summing element 1008 is also operatively coupled to the input element 1010 that relays an input signal thereto. As a result, the summing element 1008 compares a first movement, position, and/or force associated with the feedback signal to a second movement, position, and/or force associated with the input signal. The summing element 1008 outputs an error signal indicative of a difference between the first movement, position, and/or force and the second movement, position, and/or force. Further, the signal amplifier and relay 1014 adjusts one or more output pressures delivered to the actuator 104 based on the error signal. For example, the signal amplifier and relay 1014 can be implemented by the output pressure system 128 and the pneumatic reversing relay 131 of FIGS. 1-9.

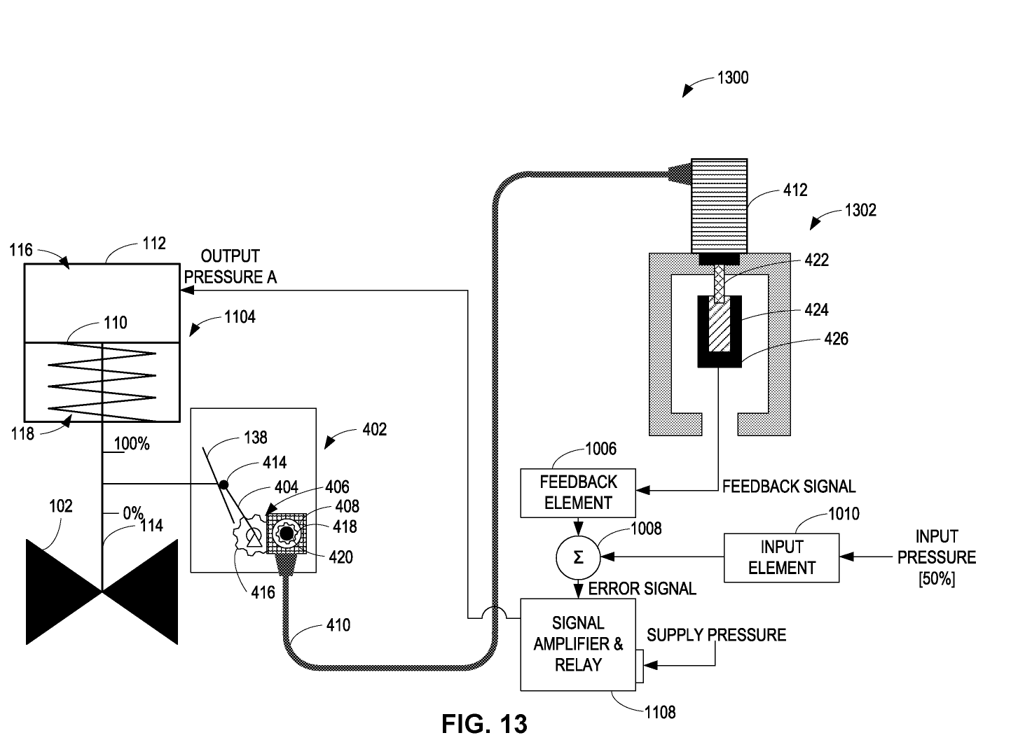

FIG. 13 is another schematic representation of another example travel feedback system 1300 including another example implementation of the coupler 402 of FIGS. 4-6 and 12. Specifically, FIG. 13 is a schematic representation of another example pressurized fluid supply 1302 and the example actuator 1104 operatively coupled to the coupler 402. The pressurized fluid supply 1302 includes the bore 424, the plate 426, the feedback element 1006, the summing element 1008, the input element 1010, and the signal amplifier and relay 1108.

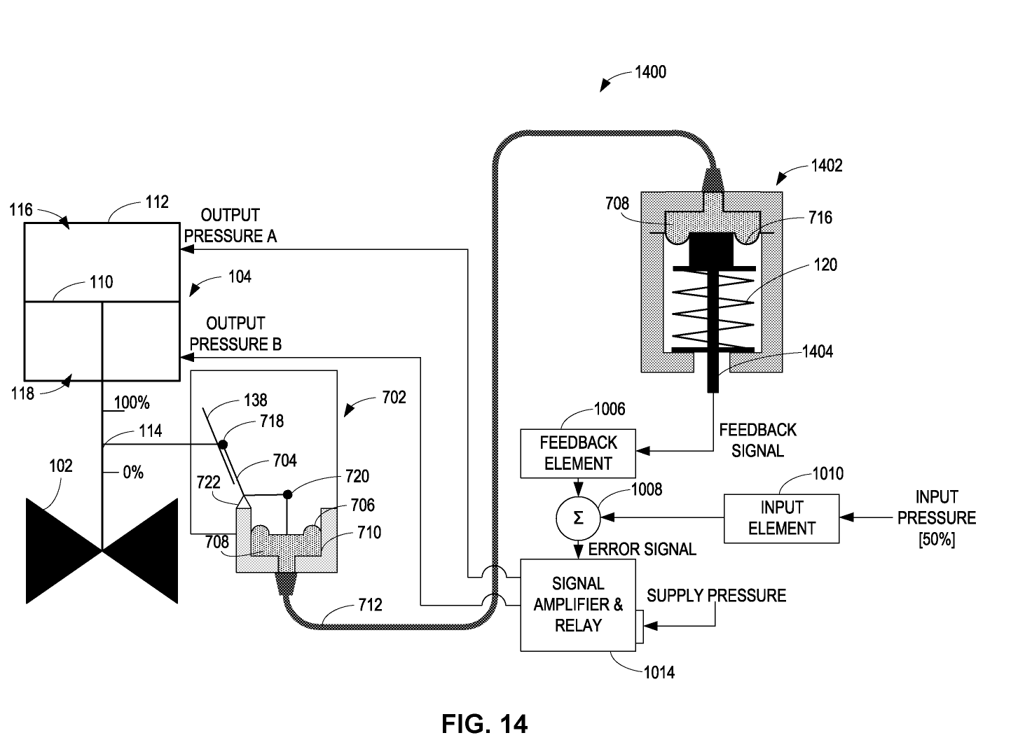

FIG. 14 is a schematic representation of another example travel feedback system 1400 including another example implementation of the coupler 702 of FIGS. 7-9. Specifically, FIG. 14 includes a schematic representation of another example pressurized fluid supply 1402 operatively coupled to the coupler 702 and the actuator 104. In this example, the coupler 702 provides a feedback signal to the pressurized fluid supply 1402 in the form of a movement/position of the diaphragm 716 and/or a force that the diaphragm 716 applies on the spring 120. In some examples, the feedback signal results in movement of a rod 1404 fixedly coupled to the diaphragm 716 and an end of the spring 120. In some such examples, the movement of the rod 1404 can result in a movement of and/or force against another component that relays the feedback signal to the feedback element 1006. In turn, the feedback element 1006 can relay the feedback signal to the summing element 1008.

Additionally, the input element 1010 can relay the input signal to the summing element 1008 in the form of a movement/position and/or a force. As a result, the summing element 1008 compares a first movement, position, and/or force associated with the feedback signal to a second movement, position, and/or force associated with the input signal. The summing element 1008 outputs an error signal indicative of a difference between the first movement, position, and/or force and the second movement, position, and/or force. The signal amplifier and relay 1014 that adjusts one or more output pressures delivered to the actuator 104 based on the error signal.

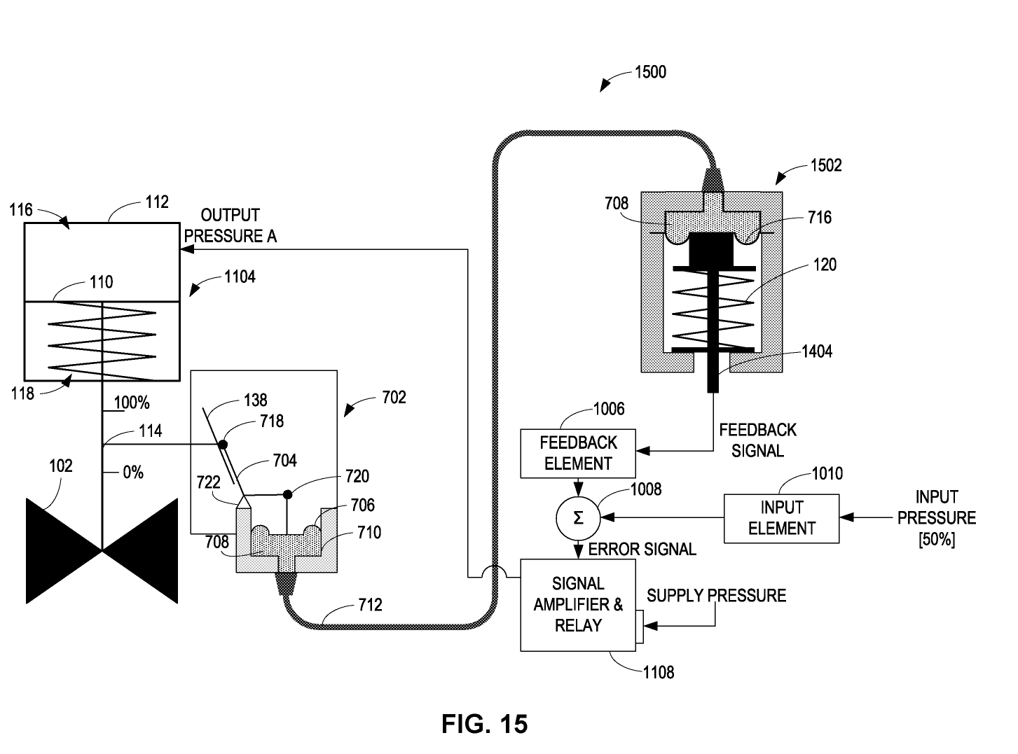

FIG. 15 is another schematic representation of another example travel feedback system 1500 including another example implementation of the coupler 702 of FIGS. 7-9 and 14. Specifically, FIG. 15 is a schematic representation of another example pressurized fluid supply 1502 and the example actuator 1104 operatively coupled to the coupler 702. The pressurized fluid supply 1502 includes the spring 120, the rod 1404, the feedback element 1006, the summing element 1008, the input element 1010, and the signal amplifier and relay 1108.

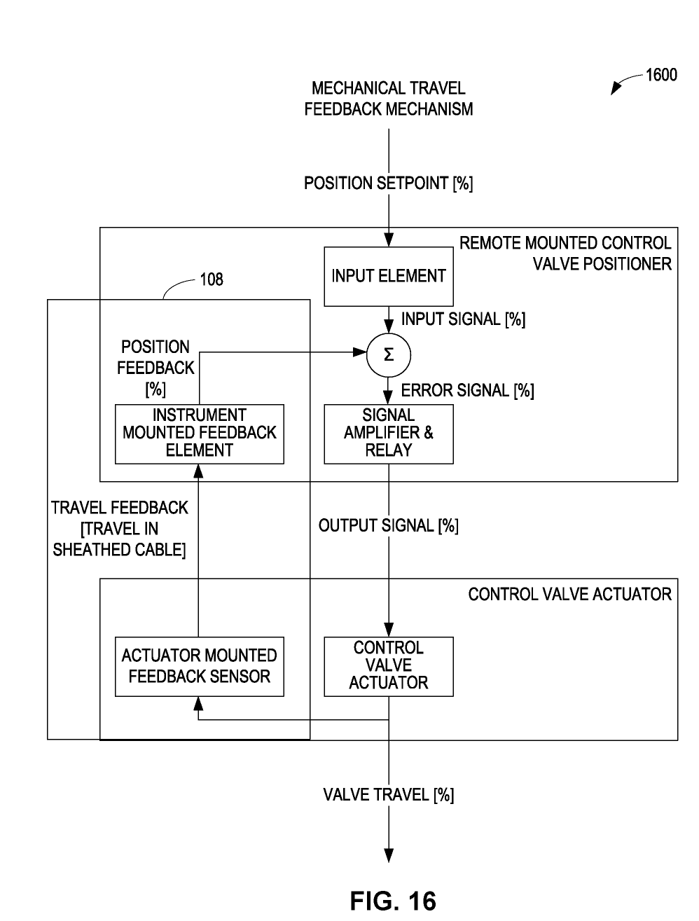

FIG. 16 is a block diagram representative of a travel feedback system 1600 (e.g., the travel feedback system 100 of FIGS. 1-3, the travel feedback system 1000 of FIG. 10, and the travel feedback system 1100 of FIG. 11) including the coupler 108.

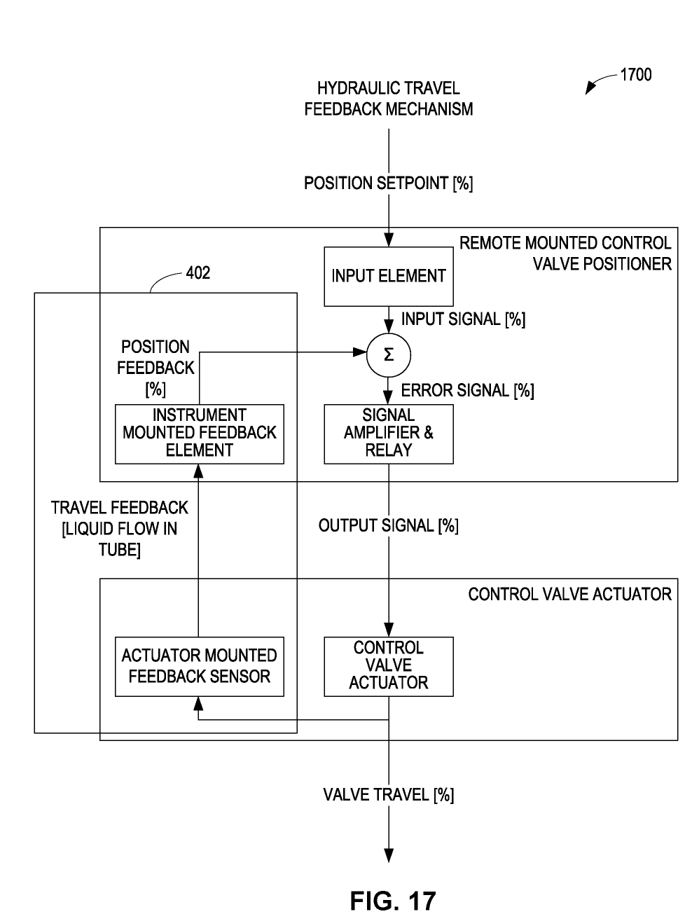

FIG. 17 is a block diagram representative of a travel feedback system 1700 (e.g., the travel feedback system 400 of FIGS. 4-6, the travel feedback system 1200 of FIG. 12, and the travel feedback system 1300 of FIG. 13) including the coupler 402.

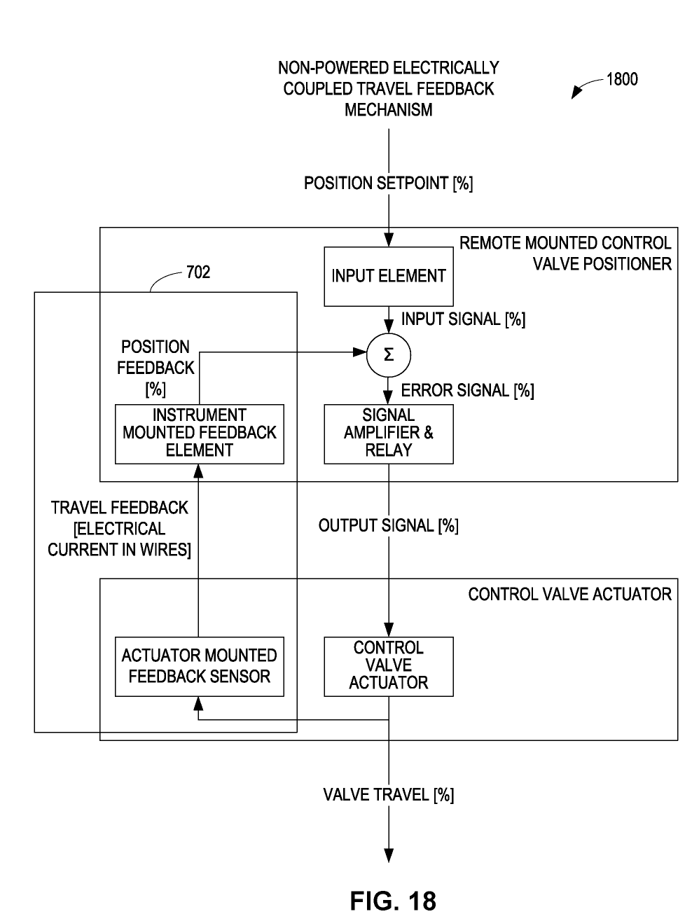

FIG. 18 is a block diagram representative of a travel feedback system 1800 (e.g., the travel feedback system 700 of FIGS. 7-9, the travel feedback system 1400 of FIG. 14, and the travel feedback system 1500 of FIG. 15) including the coupler 702.

Although examples disclosed herein are discussed in the context of a linearly moving actuator, it should be understood that the examples disclosed herein can also be utilized in conjunction with an actuator that utilizes rotation to adjust a valve position. Further, although examples disclosed herein are discussed in the context of valve control, it should be understood that the example travel feedback systems disclosed herein can be utilized with other devices, such as vanes.

In some examples, a position feedback system in accordance with the examples disclosed herein includes means for adjusting fluid flow. For example, the means for adjusting fluid flow can correspond to the valve 102, a vane, and/or functional equivalents thereof.

In some examples, a position feedback system in accordance with the examples disclosed herein includes means for actuating the means for adjusting fluid flow. For example, the means for actuating can correspond to the actuator 104 (e.g., a double acting piston actuator), a single acting actuator, such as a single acting spring return actuator and/or a diaphragm single acting actuator (e.g., Fisher Type 657/667), a piston single or double acting actuator (e.g., Bettis G-Series), and/or functional equivalents thereof.

In some examples, a position feedback system in accordance with the examples disclosed herein includes means for positioning the means for actuating. For example, the means for positioning can be implemented by the pressurized fluid supply 106 of FIGS. 1-3, the pressurized fluid supply 403 of FIGS. 4-9, the pressurized fluid supply 1002 of FIG. 10, the pressurized fluid supply 1102 of FIG. 11, the pressurized fluid supply 1202 of FIG. 12, the pressurized fluid supply 1302 of FIG. 13, the pressurized fluid supply 1402 of FIG. 14, the pressurized fluid supply 1502 of FIG. 15, and/or functional equivalents thereof.

In some examples, a position feedback system in accordance with the examples disclosed herein includes means for adjusting a feedback signal in the means for positioning based on a position of the means for actuating. For example, the means for adjusting can be implemented by the coupler 108 of FIGS. 1-3, the coupler 402 of FIGS. 4-6, and/or the coupler 702 of FIG. 7.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/- 5% unless otherwise specified herein.

From the foregoing, it will be appreciated that example systems, apparatus, articles of manufacture, and methods have been disclosed that enable a pressurized fluid supply to be spaced apart from (e.g., mounted in a remote location relative to) a valve and/or actuator associated therewith. As such, the examples disclosed herein enable the travel position feedback to be provided to the pressurized fluid supply without requiring the pressurized fluid supply to be mounted on the valve and/or the actuator, which would otherwise cause the pressurized fluid supply to be susceptible to vibrations and/or fluid leakage. The examples disclosed herein also provide the travel feedback information to the pressurized fluid supply without utilization of an active electrical power supply. Specifically, the active electrical power supply would otherwise be utilized with a remotely mounted fluid supply to power a position sensor at the valve and/or actuator, a transmitter associated with the position sensor, and circuitry at the fluid supply.

Example remote travel feedback systems and related methods are disclosed herein. Further examples and combinations thereof include the following:

Example 1 includes a valve position feedback system comprising a valve, an actuator operatively coupled to the valve, a pressurized fluid supply fluidly coupled to the actuator, the fluid supply spaced apart from the valve and the actuator, and a coupler to operatively couple the actuator to the fluid supply, the coupler to adjust a feedback signal in the fluid supply based on a position of the actuator, the fluid supply to provide an output to the actuator based on the feedback signal and an input signal.

Example 2 includes the valve position feedback system of any preceding example, wherein the coupler includes a mechanical linkage and a cable, wherein the mechanical linkage includes a first end coupled to the actuator and a second end coupled to the cable, wherein movement of the mechanical linkage affects a tension in the cable, and wherein the feedback signal varies with the tension in the cable.

Example 3 includes the valve position feedback system of any preceding example, wherein the fluid supply includes a spring and a diaphragm, wherein a first end of the spring is coupled to a first side of the diaphragm, wherein a second side of the diaphragm is exposed to the input signal, and wherein an end of the cable opposite the mechanical linkage is coupled to a second end of the spring to cause a compression of the spring and the feedback signal to vary with the tension in the cable.

Example 4 includes the valve position feedback system of any preceding example, wherein the coupler includes a fluid chamber that holds a fluid, wherein a pressure of the fluid varies with a position of the actuator, and wherein the feedback signal corresponds to the pressure of the fluid.

Example 5 includes the valve position feedback system of any preceding example, wherein the coupler includes a driver stepper motor, a driven stepper motor, and an electrical coupling between the driver stepper motor and the driven stepper motor, wherein the driver stepper motor is mechanically coupled to the actuator, wherein a magnet of the driver stepper motor rotates and induces a voltage in windings of the driver stepper motor in response to movement of the actuator, and wherein the electrical coupling carries an electrical signal to the driven stepper motor that corresponds to the voltage in the windings of the driver stepper motor.

Example 6 includes the valve position feedback system of any preceding example, wherein the electrical signal causes the driven stepper motor to change a compression in a spring that produces the feedback signal.

Example 7 includes the valve position feedback system of any preceding example, wherein the electrical signal causes the driven stepper motor to move a plate associated with the feedback signal.

Example 8 includes the valve position feedback system of any preceding example, wherein the coupler includes a lever directly engaged with the actuator.

Example 9 includes the valve position feedback system of any preceding example, wherein the coupler is operable without an active electrical power supply.

Example 10 includes the valve position feedback system of any preceding example, wherein the feedback signal corresponds to a force that coupler applies to a portion of the pressurized fluid supply.

Example 11 includes the valve position feedback system of any preceding example, wherein the feedback signal corresponds to a movement that coupler causes in the pressurized fluid supply.

Example 12 includes a system comprising a pressurized fluid supply system to be fluidly coupled to an actuator, the fluid supply system to be mounted in a remote location relative to the actuator, the fluid supply system to provide an output to the actuator based on a feedback signal and an input signal, and a coupler to couple the actuator to the fluid supply system, the coupler to be directly engaged with the actuator to cause a portion of the coupler to move with the actuator, the movement of the portion of the coupler to cause a change in the feedback signal in the fluid supply system at the remote location.

Example 13 includes the system of example 12, wherein the coupler includes a lever and a cable, wherein the lever includes a first end coupled to the actuator and a second end coupled to the cable, wherein movement of the lever affects a tension in the cable, and wherein the feedback signal varies with the tension in the cable.

Example 14 includes the system of example 12, wherein the coupler includes a fluid chamber that holds a fluid, wherein a pressure of the fluid varies with a position of the actuator, and wherein the feedback signal corresponds to the pressure of the fluid.

Example 15 includes the system of example 12, wherein the coupler includes a driver stepper motor, a driven stepper motor, and an electrical coupling between the driver stepper motor and the driven stepper motor, wherein the driver stepper motor is mechanically coupled to the actuator, wherein a magnetized shaft of the driver stepper motor rotates and induces a voltage in coils of the driver stepper motor in response to movement of the actuator, and wherein the electrical coupling carries an electrical signal to the driven stepper motor that corresponds to the voltage across the coils of the driver stepper motor.

Example 16 includes the system of example 15, wherein the electrical signal causes the driven stepper motor to change a compression in a spring that produces the feedback signal.

Example 17 includes the system of any preceding example, wherein the coupler includes a lever directly engaged with the actuator.

Example 18 includes the system of any preceding example, wherein the coupler is operable without an active electrical power supply.

Example 19 includes a valve position feedback system comprising means for adjusting fluid flow, means for actuating the means for adjusting fluid flow, means for positioning the means for actuating, the means for positioning mounted remotely from the means for actuating and the means for adjusting fluid flow, and means for adjusting a feedback signal in the means for positioning based on a position of the means for actuating, the means for positioning to adjust an output provided to the means for actuating based on the feedback signal.

Example 20 includes the valve position feedback system of any preceding example, wherein the means for adjusting the feedback signal produces a tension that varies based on the position of the means for actuating, and wherein the tension adjusts a feedback signal of the feedback signal.

Example 21 includes the valve position feedback system of any preceding example, wherein the valve position feedback system is operable without an active electrical power supply.

Example 22 includes a coupler for a travel feedback system comprising a lever including a first end and a second end, the first end operatively coupled to an actuator, the lever to pivot when the actuator moves, and a cable extending from the lever to a pressurized fluid supply spaced apart from the actuator, the cable including a first end and a second end, the first end of the cable coupled to the second end of the lever, the second end of the cable coupled to the pressurized fluid supply, the cable to adjust a feedback signal when the lever pivots, an output of the pressurized fluid supply to the actuator based on the feedback signal and an input signal.

Example 23 includes the coupler of any preceding example, wherein the second end of the cable couples to a spring of the pressurized fluid supply, wherein the cable adjusts a compression in the spring when the lever pivots, the feedback signal associated with the compression in the spring.

Example 24 includes the coupler of any preceding example, wherein the coupler is operable without an active electrical power supply.

Example 25 includes a coupler for a travel feedback system comprising a lever including a first end and a second end, the first end operatively coupled to an actuator, the lever to pivot when the actuator moves, a gear set operatively coupled to the lever, an electrical coupling a driver stepper motor operatively coupled to the gear set and the electrical coupling, the driver stepper motor including a shaft and coils, the shaft to rotate when the gear set rotates, the coils to carry an electrical current when the shaft rotates, and a driven stepper motor operatively coupled to the electrical coupling, the driven stepper motor including a shaft operatively coupled to a pressurized fluid supply, the electrical coupling to carry the electrical current from the coils of the driver stepper motor to the driven stepper motor to cause the shaft of the driven stepper motor to rotate, the rotation of the shaft of the driven stepper motor to adjust a feedback signal, an output of the pressurized fluid supply to the actuator based on the feedback signal and an input signal.

Example 26 includes the coupler of any preceding example, wherein the shaft is operatively coupled to a spring of the pressurized fluid supply, wherein the rotation of the shaft adjusts a compression in the spring, the feedback signal associated with the compression in the spring.

Example 27 includes the coupler of any preceding example, wherein the coupler is operable without an active electrical power supply.

Example 28 includes a coupler for a travel feedback system comprising a lever including a first end and a second end, the first end operatively coupled to an actuator, the lever to pivot when the actuator moves, a tube, a first diaphragm defining an end of a first chamber including a fluid, the first chamber fluidly coupled to the tube, the first diaphragm operatively coupled to the second end of the lever, the first diaphragm to expand or contract in response to movement of the lever to increase or decrease a size of the first chamber, and a second diaphragm defining an end of a second chamber including the fluid, the second chamber fluidly coupled to the tube, an amount of the fluid to in the second chamber to increase when the first diaphragm contracts, the amount of the fluid in the second chamber to decrease when the second diaphragm expands, the second diaphragm operatively coupled to a pressurized fluid supply, the amount of the fluid in the second chamber to adjust a feedback signal, an output of the pressurized fluid supply to the actuator based on the feedback signal and an input signal.

Example 29 includes the coupler of any preceding example, wherein the second diaphragm is operatively coupled to a spring of the pressurized fluid supply, wherein the amount of fluid in the second chamber adjusts a compression in the spring, the feedback signal associated with the compression in the spring.

Example 30 includes the coupler of any preceding example, wherein the coupler is operable without an active electrical power supply.

Example 31 includes the valve position feedback system of example 4, wherein the fluid supply includes a first diaphragm, a second diaphragm, and a spring coupled to the first diaphragm and the second diaphragm, wherein the fluid is positioned on a side of the first diaphragm opposite the spring to cause the pressure of the fluid to change a compression of the spring against the second diaphragm, and wherein a side of the second diaphragm opposite the spring is exposed to the input signal.

Example 32 includes the system of any preceding example, wherein the pressurized fluid supply system includes a spring and a diaphragm, wherein a first end of the spring is coupled to a first side of the diaphragm, wherein a second side of the diaphragm is exposed to the input signal, and wherein an end of the cable opposite the lever is coupled to a second end of the spring to cause a compression of the spring and the feedback signal to vary with the tension in the cable.

Example 33 includes the system of any preceding example, wherein the pressurized fluid supply includes a first diaphragm, a second diaphragm, and a spring coupled to the first diaphragm and the second diaphragm, wherein the fluid is positioned on a side of the first diaphragm opposite the spring to cause the pressure of the fluid to change a compression of the spring against the second diaphragm, and wherein a side of the second diaphragm opposite the spring is exposed to the input signal.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A valve position feedback system comprising:
a valve;
an actuator operatively coupled to the valve;
a pressurized fluid supply fluidly coupled to the actuator, the fluid supply spaced apart from the valve and the actuator; and
a coupler to operatively couple the actuator to the fluid supply, the coupler to adjust a feedback signal in the fluid supply based on a position of the actuator, the fluid supply to provide an output to the actuator based on the feedback signal and an input signal.

2. The valve position feedback system of claim 1, wherein the coupler includes a mechanical linkage and a cable, wherein the mechanical linkage includes a first end coupled to the actuator and a second end coupled to the cable, wherein movement of the mechanical linkage affects a tension in the cable, and wherein the feedback signal varies with the tension in the cable.

3. The valve position feedback system of claim 2, wherein the fluid supply includes a spring and a diaphragm, wherein a first end of the spring is coupled to a first side of the diaphragm, wherein a second side of the diaphragm is exposed to the input signal, and wherein an end of the cable opposite the mechanical linkage is coupled to a second end of the spring to cause a compression of the spring and the feedback signal to vary with the tension in the cable.

4. The valve position feedback system of claim 1, wherein the coupler includes a fluid chamber that holds a fluid, wherein a pressure of the fluid varies with a position of the actuator, and wherein the feedback signal corresponds to the pressure of the fluid.

5. The valve position feedback system of claim 1, wherein the coupler includes a driver stepper motor, a driven stepper motor, and an electrical coupling between the driver stepper motor and the driven stepper motor, wherein the driver stepper motor is mechanically coupled to the actuator, wherein a magnet of the driver stepper motor rotates and induces a voltage in windings of the driver stepper motor in response to movement of the actuator, and wherein the electrical coupling carries an electrical signal to the driven stepper motor that corresponds to the voltage in the windings of the driver stepper motor.

6. The valve position feedback system of claim 5, wherein the electrical signal causes the driven stepper motor to change a compression in a spring that produces the feedback signal.

7. The valve position feedback system of claim 5, wherein the electrical signal causes the driven stepper motor to move a plate associated with the feedback signal.

8. The valve position feedback system of claim 1, wherein the coupler includes a lever directly engaged with the actuator.

9. The valve position feedback system of claim 1, wherein the coupler is operable without an active electrical power supply.

10. The valve position feedback system of claim 1, wherein the feedback signal corresponds to a force that coupler applies to a portion of the pressurized fluid supply.

11. The valve position feedback system of claim 1, wherein the feedback signal corresponds to a movement that coupler causes in the pressurized fluid supply.

12. A system comprising:
a fluid supply system to be fluidly coupled to an actuator, the fluid supply system to be mounted in a remote location relative to the actuator, the fluid supply system to provide an output to the actuator based on a feedback signal and an input signal; and
a coupler to couple the actuator to the fluid supply system, the coupler to be directly engaged with the actuator to cause a portion of the coupler to move with the actuator, the movement of the portion of the coupler to cause a change in the feedback signal in the fluid supply system at the remote location.

13. The system of claim 12, wherein the coupler includes a lever and a cable, wherein the lever includes a first end coupled to the actuator and a second end coupled to the cable, wherein movement of the lever affects a tension in the cable, and wherein the feedback signal varies with the tension in the cable.

14. The system of claim 12, wherein the coupler includes a fluid chamber that holds a fluid, wherein a pressure of the fluid varies with a position of the actuator, and wherein the feedback signal corresponds to the pressure of the fluid.

15. The system of claim 12, wherein the coupler includes a driver stepper motor, a driven stepper motor, and an electrical coupling between the driver stepper motor and the driven stepper motor, wherein the driver stepper motor is mechanically coupled to the actuator, wherein a magnetized shaft of the driver stepper motor rotates and induces at least one of a voltage or a current in coils of the driver stepper motor in response to movement of the actuator, and wherein the electrical coupling carries an electrical signal to the driven stepper motor that corresponds to at least one of the voltage or the current across the coils of the driver stepper motor.

16. The system of claim 15, wherein the electrical signal causes the driven stepper motor to change a compression in a spring that produces the feedback signal.

17. The system of claim 12, wherein the coupler includes a lever directly engaged with the actuator.

18. The system of claim 12, wherein the coupler is operable without an active electrical power supply.

19. A valve position feedback system comprising:
means for adjusting fluid flow;
means for actuating the means for adjusting fluid flow;
means for positioning the means for actuating, the means for positioning mounted remotely from the means for actuating and the means for adjusting fluid flow; and
means for adjusting a feedback signal in the means for positioning based on a position of the means for actuating, the means for positioning to adjust an output provided to the means for actuating based on the feedback signal.

20. The valve position feedback system of claim 19, wherein the means for adjusting the feedback signal produces a tension that varies based on the position of the means for actuating, and wherein the tension adjusts the feedback signal of the feedback signal.

21. The valve position feedback system of claim 19, wherein the valve position feedback system is operable without an active electrical power supply.

22. A coupler for a travel feedback system comprising:
a lever including a first end and a second end, the first end operatively coupled to an actuator, the lever to pivot when the actuator moves; and
a cable extending from the lever to a pressurized fluid supply spaced apart from the actuator, the cable including a first end and a second end, the first end of the cable coupled to the second end of the lever, the second end of the cable coupled to the pressurized fluid supply, the cable to adjust a feedback signal when the lever pivots, an output of the pressurized fluid supply to the actuator based on the feedback signal and an input signal.

23. The coupler of claim 22, wherein the second end of the cable couples to a spring of the pressurized fluid supply, wherein the cable adjusts a compression in the spring when the lever pivots, the feedback signal associated with the compression in the spring.

24. The coupler of claim 22, wherein the coupler is operable without an active electrical power supply.

25. A coupler for a travel feedback system comprising:
a lever including a first end and a second end, the first end operatively coupled to an actuator, the lever to pivot when the actuator moves;
a gear set operatively coupled to the lever;
an electrical coupling
a driver stepper motor operatively coupled to the gear set and the electrical coupling, the driver stepper motor including a shaft and coils, the shaft to rotate when the gear set rotates, the coils to carry an electrical current when the shaft rotates; and
a driven stepper motor operatively coupled to the electrical coupling, the driven stepper motor including a shaft operatively coupled to a pressurized fluid supply, the electrical coupling to carry the electrical current from the coils of the driver stepper motor to the driven stepper motor to cause the shaft of the driven stepper motor to rotate, the rotation of the shaft of the driven stepper motor to adjust a feedback signal, an output of the pressurized fluid supply to the actuator based on the feedback signal and an input signal.

26. The coupler of claim 25, wherein the shaft is operatively coupled to a spring of the pressurized fluid supply, wherein the rotation of the shaft adjusts a compression in the spring, the feedback signal associated with the compression in the spring.

27. The coupler of claim 25, wherein the coupler is operable without an active electrical power supply.

28. A coupler for a travel feedback system comprising:
a lever including a first end and a second end, the first end operatively coupled to an actuator, the lever to pivot when the actuator moves;
a tube;
a first diaphragm defining an end of a first chamber including a fluid, the first chamber fluidly coupled to the tube, the first diaphragm operatively coupled to the second end of the lever, the first diaphragm to expand or contract in response to movement of the lever to increase or decrease a size of the first chamber; and
a second diaphragm defining an end of a second chamber including the fluid, the second chamber fluidly coupled to the tube, an amount of the fluid to in the second chamber to increase when the first diaphragm contracts, the amount of the fluid in the second chamber to decrease when the second diaphragm expands, the second diaphragm operatively coupled to a pressurized fluid supply, the amount of the fluid in the second chamber to adjust a feedback signal, an output of the pressurized fluid supply to the actuator based on the feedback signal and an input signal.

29. The coupler of claim 28, wherein the second diaphragm is operatively coupled to a spring of the pressurized fluid supply, wherein the amount of fluid in the second chamber adjusts a compression in the spring, the feedback signal associated with the compression in the spring.

30. The coupler of claim 28, wherein the coupler is operable without an active electrical power supply.
